(19) United States
(12) Patent Application Publication
(10) Pub. No.: US 2017/0116198 A1
(43) Pub. Date: Apr. 27, 2017

(54) Methods And Systems For Updating A Search

(71) Applicant: Lunatech, LLC, Studio City, CA (US)

(72) Inventor: John Cameron, Studio City, CA (US)

(21) Appl. No.: 15/332,499

(22) Filed: Oct. 24, 2016

Related U.S. Application Data
(60) Provisional application No. 62/245,685, filed on Oct. 23, 2015.

(51) Int. Cl. G06F 17/30

(52) U.S. Cl. CPC G06F 17/3053; G06F 17/30867

(57) ABSTRACT

In some embodiments, a method may include performing a search for a first search query based on a first state of being construct, determining a plurality of state of being constructs that have also been used to perform a search for the first search query, determining a second state of being construct based on a commonality between the plurality of state of being constructs, determining a difference between the first state of being construct and the second state of being construct, resulting in a third state of being construct, and performing the search for the first search query based on the third state of being construct.

### CROSS REFERENCE TO RELATED PATENT APPLICATION

This application claims priority to U.S. Provisional Application No. 62/245,685 filed Oct. 23, 2015, incorporated herein by reference in its entirety.

### BACKGROUND

The expansion of the World Wide Web allows consumers to quickly gain access to a significant amount of information from many different information providers. Unfortunately, what often results is irrelevant information overload because there is as yet no way for a consumer to obtain information that describes who the consumer is at that moment or who the user wishes to be in the future. These and other shortcomings are addressed by the present disclosure.

### BRIEF SUMMARY

In some embodiments, a method may include performing a search for a first search query based on a first state of being construct, determining a plurality of state of being constructs that have also been used to perform a search for the first search query, determining a second state of being construct based on a commonality between the plurality of state of being constructs, determining a difference between the first state of being construct and the second state of being construct, resulting in a third state of being construct, and performing the search for the first search query based on the third state of being construct.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an aspect of the subject matter in accordance with one embodiment.

FIG. 2 illustrates an aspect of the subject matter in accordance with one embodiment.

FIG. 3 illustrates an aspect of the subject matter in accordance with one embodiment.

FIG. 4 illustrates an aspect of the subject matter in accordance with one embodiment.

FIG. 5 illustrates an aspect of the subject matter in accordance with one embodiment.

FIG. 6 illustrates an aspect of the subject matter in accordance with one embodiment.

FIG. 7 illustrates an aspect of the subject matter in accordance with one embodiment.

FIG. 8 illustrates an aspect of the subject matter in accordance with one embodiment.

FIG. 9 illustrates an aspect of the subject matter in accordance with one embodiment.

FIG. 10 illustrates an aspect of the subject matter in accordance with one embodiment.

FIG. 11 illustrates a routine in accordance with one embodiment.

FIG. 12 illustrates a routine in accordance with one embodiment.

FIG. 13 illustrates a routine in accordance with one embodiment.

FIG. 14 illustrates a routine in accordance with one embodiment.

FIG. 15 illustrates a routine in accordance with one embodiment.

FIG. 16 illustrates a routine in accordance with one embodiment.

FIG. 17 illustrates a routine in accordance with one embodiment.

FIG. 18 illustrates a routine in accordance with one embodiment.

FIG. 19 illustrates a routine in accordance with one embodiment.

FIG. 20 illustrates a routine in accordance with one embodiment.

FIG. 21 illustrates a routine in accordance with one embodiment.

FIG. 22 illustrates a routine in accordance with one embodiment.

FIG. 23 illustrates a routine in accordance with one embodiment.

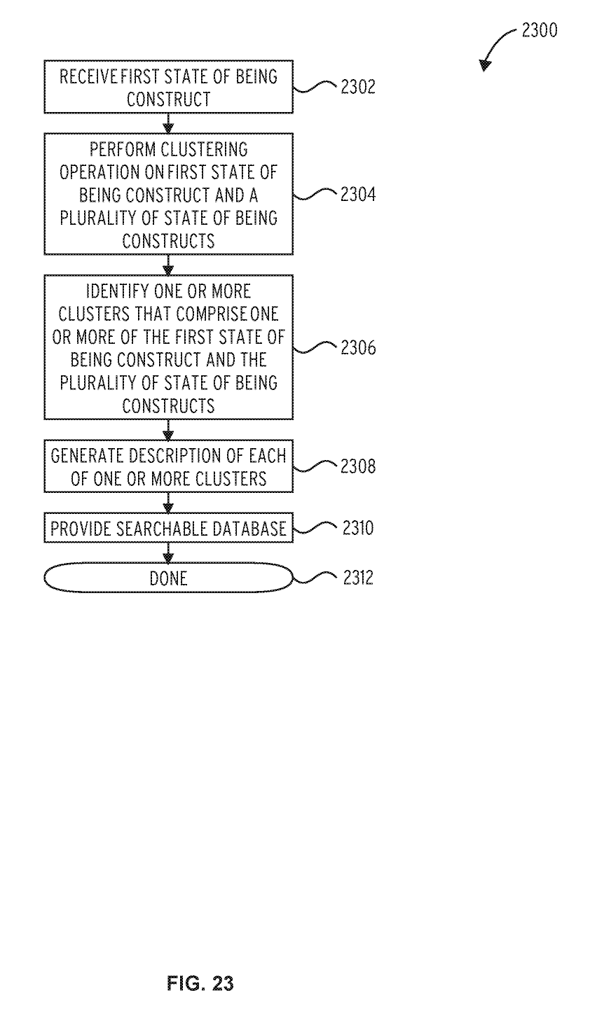

FIG. 24 illustrates a routine in accordance with one embodiment.

FIG. 25 illustrates a routine in accordance with one embodiment.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes—from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

As will be described in greater detail herein, systems and methods provided can perform a search of a network, for example the Internet, in an aspect, the search can be a “progress search.” Progress search can refer to a search that generates search results based on who the searcher (e.g., user) wants to be. In an aspect, progress search can take into account one or both of who the user is and/or who the user wants to be. Who the user is and/or who the user wants to be can be embodied in a state of being construct. The state of being construct can comprise a data structure, such as an array, a list, a tree, combinations thereof, and the like. The data structure can be configured for searching and/or filtering one or more search results and/or one or more search queries. The state of being construct can comprise information in one or more domains (e.g., topics, categories, etc. . . . ). For example, the state of being construct can comprise one or more of a religion domain, a politics domain, a financial domain, a geographic domain, a racial domain, a physical health domain, a mental health domain, combinations thereof, and the like. In an aspect, the state of being construct can comprise information related to a user at a present state (e.g., a current weight, a current age, etc. . . . ). In another aspect, the state of being construct can comprise information related to a user at a future state (e.g., a future weight, a future age, etc. . . . ). The information related to the user can be within the one or more domains. The one or more domains can comprise a weight that comprises a value indicative of an importance of the domain. The state of being construct can comprise a time component that comprises a value indicative of an amount of time a user is willing to dedicate. For example, the user can indicate that information within a domain and/or the domain itself is associated with a particular time frame (e.g., 1 day, 1 month, 1 year, 10 years, etc. . . . ). The state of being construct can comprise a force component that comprises a value indicative of a level of effort required by a user. For example, the user can indicate how committed the user is to the information within a domain and/or the domain itself (e.g., a value of 1 can represent that the user is not very committed whereas a value of 10 can represent that the user is very committed).

The search can be performed by a progress search engine configured to find information stored on a computer network such as the Internet or a personal computer. The progress search engine can use regularly updated indexes to operate quickly and efficiently. The progress search engine can refer to a Web, or Internet, search engine, which searches for information on the public Web. Also specifically contemplated herein are enterprise search engines, which search on intranets, personal search engines, which search individual personal computers, mobile search engines, and combinations thereof.

The progress search engine can operate algorithmically to crawl electronic documents, index the electronic documents, and search the index. The progress search engine can retrieve a list of search results responsive to a search query. The search query can be user-defined. The search query can comprise one or more search terms. A user-defined search term can be, for example, a keyword, a phrase, a question, a street address, a product name, an image, combinations thereof, and the like. Search results can be any electronic file, including by way of example and not limitation, Active Server Page script files, Bitmap image files, Cold Fusion script files, Common Gateway Interface script/program files, Cascading Style Sheet markup tiles. Comma Separated Value text files, Dynamic HyperText Markup Language tiles, Microsoft Word Document files, Graphics Interchange Format image files, HyperText Markup Language (HTM or HTML) files, Joint Photographic Experts Group image files, Adobe Acrobat Portable Document Files, Perl script files, Portable Network Graphics image files, Rich Text Format document files, Tagged Image File Format image files, Plain Text files, Extensible Markup Language files, combinations thereof, and the like.

search results can be transmitted over the World Wide Web utilizing the Hypertext Transfer Protocol (HTTP) or HTTPS, which is the secure version of HTTP. Search results can have an address (Uniform Resource Indicator (URI)) which appears in the address bar of a web browser. Addresses can have prefixes of which HTTP and HTTPS are two kinds. HTTP is the set of rules for exchanging electronic files (text, graphic images, sound, video, and other multimedia files) on the World Wide Web. Relative to the TCP/IP suite of protocols (which are the basis for information exchange on the Internet), HTTP is an application protocol. HTTP is the most popular URI scheme used on the World Wide Web. The HTTP scheme defines the scheme-specific part of its absolute URI as a string of characters beginning with two slashes, followed by authority (host name with optional port number, separated by a column), followed by an optional path part, and followed by an optional query part, separated from the previous part with a question mark.

The secure hypertext transfer protocol (HTTPS) is a communications protocol designed to transfer encrypted information between computers over the World Wide Web. HTTPS is HTTP using a Secure Socket Layer (SSL). HTTPS is a URI scheme equivalent to the http scheme. It signals the web browser to use HTTP with added encryption layer of SSL/TLS to protect the traffic. SSL is especially suited for HTTP since it can provide some protection even if only one side to the communication is authenticated.

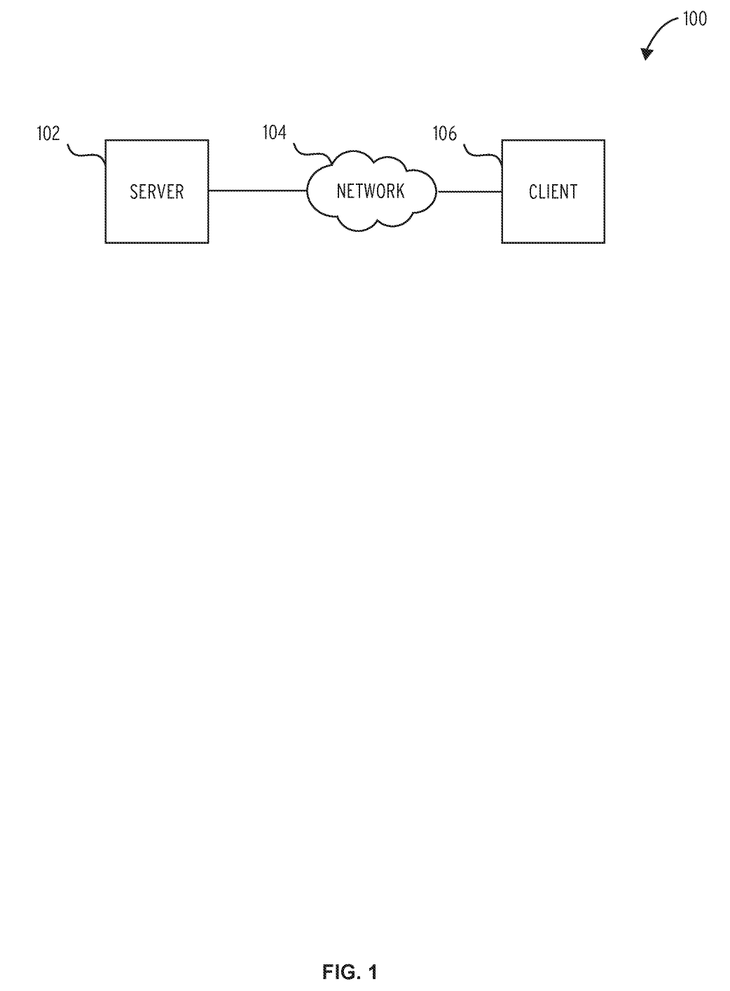

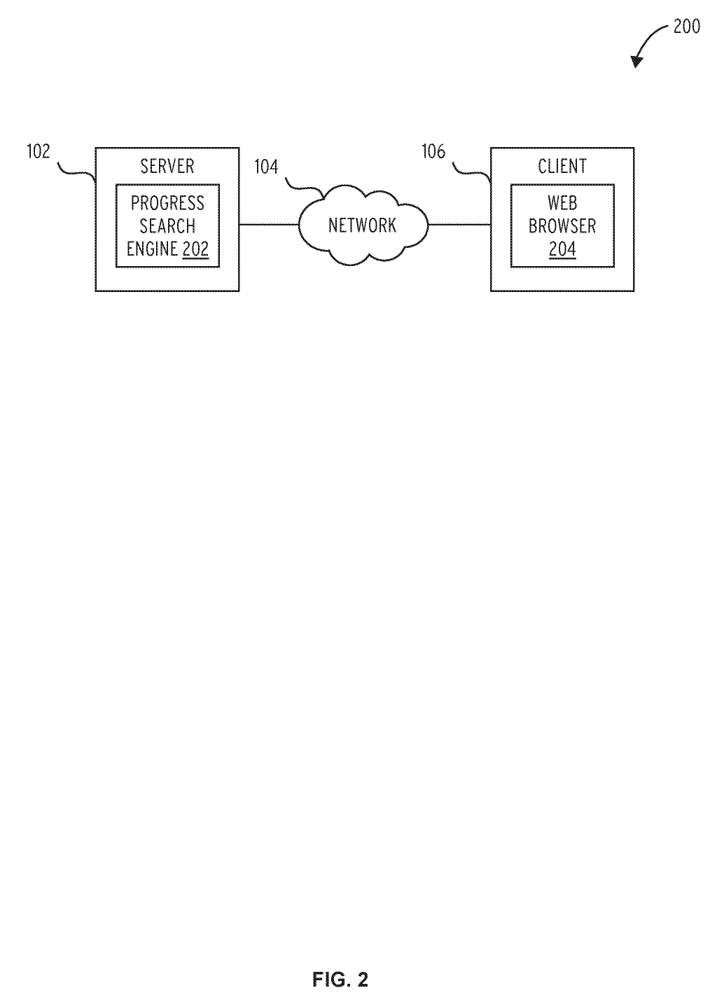

FIG. 1 and FIG. 2 are block diagrams depicting non-limiting examples of a server 102 and a client 106 connected through a network 104 according to an aspect. The server 102 can comprise one or multiple computers configured to operate a progress search engine 202. The client 106 can comprise one or multiple computers configured to operate a web browser 204 such as, for example, a laptop computer or a desktop computer. Multiple clients 102 can connect to the server 102 through a network 104 such as, for example, the Internet. A user on a client 106 may connect to the progress search engine 202 with the web browser 204.

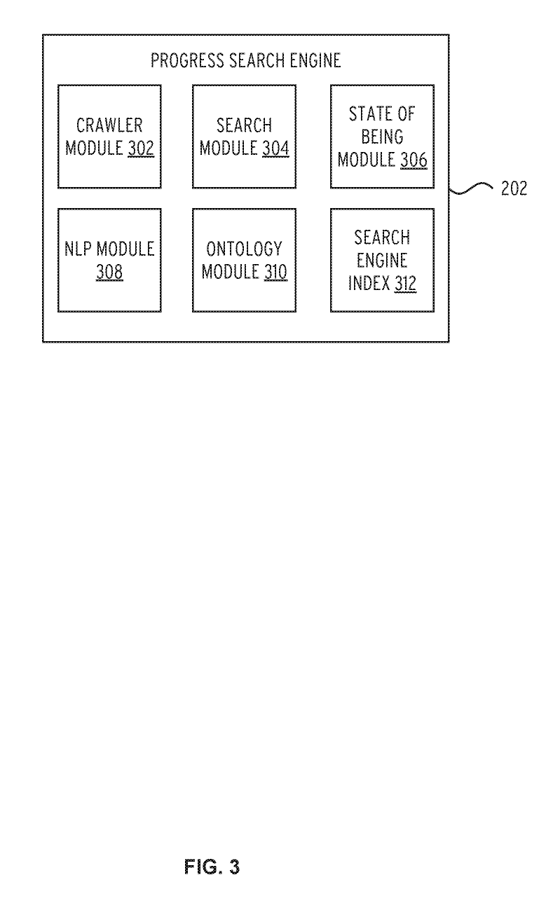

A progress search engine can be configured to create and/or filter search results based on one or more state of being constructs. FIG. 3 is block diagram depicting an exemplary view of a progress search engine 202 according to an aspect. The progress search engine 202 can provide search results responsive to a user-defined search term. In one aspect, the progress search engine 202 can filter search results received from another search engine based on one or more state of being constructs. In another aspect, the progress search engine 202 can generate search results from a user-defined search term based on one or more state of being constructs. The progress search engine 202 can comprise one or more of, a crawler module 302, a search module 304, a state of being module 306, a natural language processing (NLP) module 308, an ontology module 310, and a search engine index 312. Crawler module 302 can retrieve and analyze electronic documents to determine how to index the electronic documents. Data about the electronic documents can be stored in search engine index 312 for use in queries by search module 304. The state of being module 306 can generate one or more state of being constructs based off of user input, automatic data gathering, combinations thereof, and the like. The state of being module 306 can filter search results returned by the search module 304 and/or can operate in conjunction with the search module 304 to modify the manner in which the search module 304 obtains search results.

The search module 304 can be configured to perform one or more types of searches. In an aspect, the search module 304 can be configured to perform a keyword search and/or a semantic search. A keyword search is a type of search that looks for matching documents (electronic files) that contain one or more words specified by a user. Semantic search seeks to improve search accuracy by understanding searcher intent and the contextual meaning of terms as they appear in the searchable dataspace, whether on the Web or within a closed system, to generate more relevant results. In an aspect, a semantic search technique can be used to build a semantic model from a set of documents (webpages, emails, or documents on a file system, for example), and given a search query, find the set of documents that best relate to that query. For example, an inverted index of all words in a document across all documents can be built, and then using various relevancy metrics, the words of the search query (assumed to be another kind of document) can be compared against the index, and a ranked set of files can be identified that are “closest” to the query. In practice, this serves to simulate semantic search because words that represent a semantic concept tend to cluster together in co-occurrences. The search module 304 can interact with one or more of the NLP module 308 and/or the ontology module 310 to effect a semantic search. For example, the search module 304 can parse a query and use the NLP module 308 and/or the ontology module 310 to develop a list of other related terms, concepts, and/or contexts that may correlate to information desired by a user. The search module 304 can thus generate related terms and/or concepts that relate to a search term using, for example, an ontology. The related terms and/or concepts can be used to expand the query to identify documents that are relevant to the query.

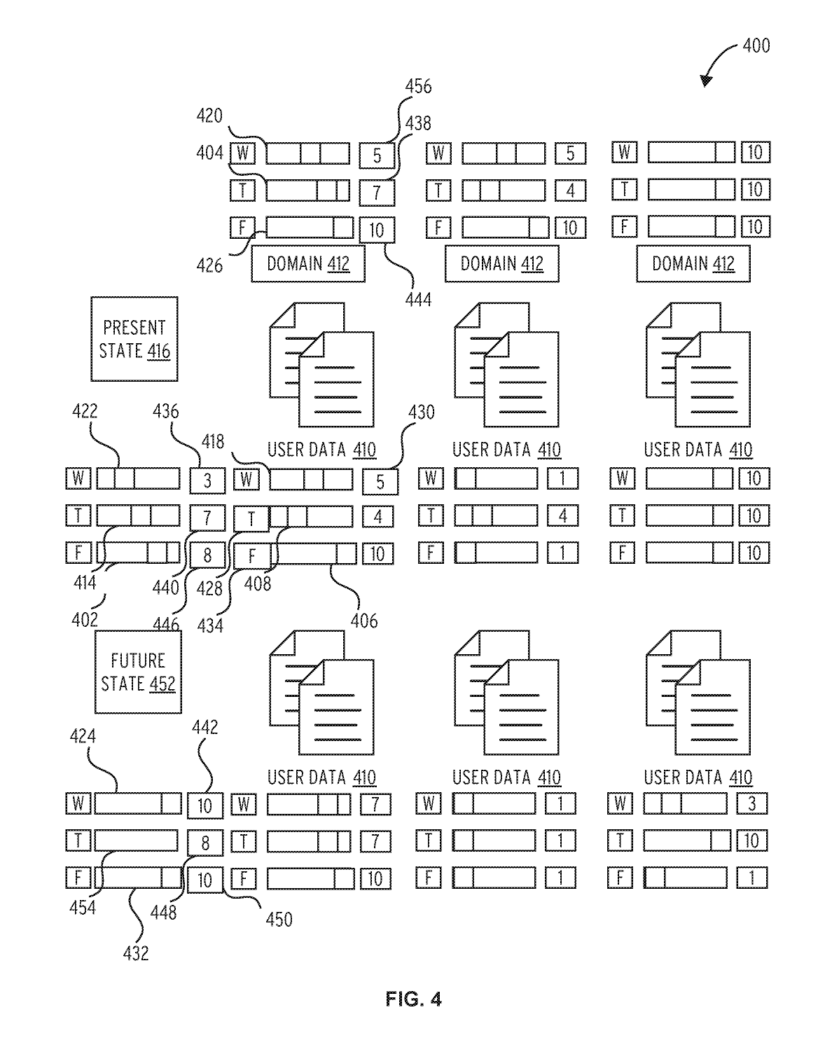

The state of being module 306 can generate a state of being construct manually and/or automatically. Moreover, the state of being module 306 can update a state of being construct manually and/or automatically. The state of being module 306 can be configured to present a user with a user interface to guide a user through the process of providing information used to generate the state of being construct. FIG. 4 is a graphical depiction of an example state of being construct 400. The state of being construct 400 can comprise user data 402 (information) in one or more domains 404 (e.g., topics, categories, etc. . . . ). For example, the state of being construct 400 can comprise one or more of a religion domain, a politics domain, a financial domain, a geographic domain, a racial domain, a physical health domain, a mental health domain, combinations thereof, and the like. In an aspect, the state of being construct 400 can comprise information related to a user at a present state 406 (e.g., a current weight, a current age, etc. . . . ). In another aspect, the state of being construct 400 can comprise information related to a user at a future state 408 (e.g., a future weight, a future age, etc. . . . ).

The information related to the user can be within the one or more domains 404. In this example, the user data 402 can have one or more weights 410 given to the user data 402 (e.g., those data that best define who the user is (present state 406) and/or wants to be (future state 408)). The one or more weights 410 can be interactively adjusted by moving a slider 412. The one or more domains 404 can comprise a weight 414 that comprises a value indicative of an importance of the domain which can be adjusted by a slider 416. The present state 406 can comprise a weight 418 that comprises a value indicative of an importance of the present state 406 that can be interactively adjusted by moving a slider 420. The future state 408 can comprise a weight 422 that comprises a value indicative of an importance of the future state 408 that can be interactively adjusted by moving a slider 424. In an aspect, the state of being 400 can comprise only the present state 406 or only the future state 408.

The user data 402 can also have a time component 426 and/or a force component 428 associated with the user data 402. The time component 426 and/or the force component 428 can be adjusted by moving a slider 430 and a slider 432, respectively. The time component 426 can be indicative of an amount of time a user is willing to dedicate. For example, the user can indicate that information within a domain and/or the domain itself is associated with a particular time frame e.g., 1 day, 1 month, 1 year, 10 years, etc. . . . ). The force component 428 can indicate a level of effort required by a user. For example, the user can indicate how committed the user is to the information within a domain and/or the domain itself (e.g., a value of 1 can represent that the user is not very committed whereas a value of 10 can represent that the user is very committed). The one or more domains 404 can also have a time component 434 and/or a force component 436 associated with the one or more domains 404. The time component 434 and/or the force component 436 can be adjusted by moving a slider 438 and a slider 440, respectively. The present state 406 can also have a time component 442 and/or a force component 444 associated with the present state 406. The time component 442 and/or the force component 444 can be adjusted by moving a slider 446 and a slider 448, respectively. The future state 408 can also have a time component 450 and/or a force component 452 associated with the future state 408. The time component 450 and/or the force component 452 can be adjusted by moving a slider 454 and a slider 456, respectively.

Returning to FIG. 3, in a further aspect, the state of being module 306 can be configured to update a state of being construct based on search results viewed by a user. For example, if a user conducts a search related to dieting and the user consistently views search results related to vegetarian diets, the state of being module 306 can modify the state of being construct to reflect that the user is a vegetarian.

In another aspect, the state of being module 306 can be configured to automatically generate a state of being construct. The state of being module 306 can retrieve data about a user from one or more data sources. By way of example, the state of being module 306 can receive user account information (e.g., username, password, etc. . . . ) for one or more data sources. The state of being module 306 can utilize the user account information to access the one or more data sources and retrieve user data. For example, a user can provide the state of being module 306 with user account information for social media accounts, social networking accounts, financial institution accounts, and any other account type that can store user data. The state of being module 306 can retrieve user data from the one or more data sources and automatically classify the user data. For example, the state of being module 306 can pass the user data to one or more of the NLP module 308 and/or the ontology module 310 to analyze and classify the user data. The classified user data can be assigned to one or more domains. For example, the state of being module 306 can retrieve tweets from a user's Twitter account that relate to a sports team. The state of being module 306, the NLP module 308, and/or the ontology module 310 can determine that the tweets are supportive of the sports team. The state of being module 306 can use that user data to populate one or more domains to which that type of user data is relevant. The state of being module 306 can use the automatic process to generate the state of being construct and can seek user input as to the accuracy of the state of being construct. The state of being module 306 can continue to monitor the one or more data sources to update/refine the state of being construct.

In a further aspect, the state of being module 306 can be configured to retrieve/receive user data from one or more devices. The user data received from the one or more devices can be used to populate a state of being construct. The state of being module 306 can be configured to receive user data from the one or more devices via one or more networks. For example, a user can use a smart watch that tracks the user's physical activity levels. The user's physical activity levels can be communicated to the state of being module 306 from the smart watch and used to create, update, and/or refine a state of being construct. Any type of device capable of gather user data can be configured to provide user data to the state of being module 306. For example, a smart watch, a smart phone, a tablet, a laptop, a desktop, a server, a vaping device, a heart monitor, a fitness tracker, a vehicle telematics device, a GPS, an automated teller machine (ATM), and combinations thereof.

In a further aspect, the state of being module 306 can be configured to store one or more state of being profiles for one or more users. The stored state of being profiles can be made available to advertisers/content providers to search/analyze to determine one or more targets for advertisements/content. In an aspect, once a state of being construct is created, the state of being module 306 can perform a clustering operation on the state of being construct and a plurality of other state of being constructs. The clustering operation can comprise, for example, performing one or more of a hierarchical clustering operation, a k-means operation, and combinations thereof. The result of the clustering operation can be one or more clusters of state of being constructs. Each cluster can be made up of state of being clusters determined to be most similar to each other based on the content of the state of being constructs. A description of each cluster can be generated and stored. The description can comprise a summary of the commonality between the state of being constructs found in each cluster (e.g., same political party affiliation, same age, same religion, etc). The descriptions can be stored in a searchable database to enable advertisers/content providers to identify target markets. In an aspect, advertisers/content providers can select one or more state of being constructs and/or one or more clusters of state of being constructs for use as targets for advertisements/content, in an aspect, the advertisers/content providers can target those selected state of being constructs to have one or more non-organic search results delivered in response to a search query.

The natural language processing (NLP) module 308 can analyze textual information from search queries, search results, indexed electronic files, combinations thereof, and the like. Textual information can be input into the NLP module 308, and the NLP module 308 can generate a cognitive model of the input text. In other words, a query in natural language can be parsed into the representation format of first-order logic and naive semantics. A naive semantic system that incorporates modules for text processing based upon parsing, formal semantics and discourse coherence, as well as relying on a naive semantic lexicon that stores word meanings in terms of a hierarchical semantic network is disclosed. The cognitive model can then passed to the search module 304, that can use a high recall statistical retrieval module (not shown) using unspecified statistical techniques to produce a list of candidate documents and a relevance reasoning module (not shown) which can use first-order theorem proving and human-like reasoning to determine which documents should be presented to the user. Textual information can be based on sentence structure, for example, based on a word-by-word analysis and/or a whole sentence analysis. In an aspect, the NLP module 308 can determine word frequencies for some or all words contained in textual information. The NLP module 308 can be configured to disambiguate and resolve homograph issues to accurately identify words and their frequencies.

The ontology module 310 which can be configured for performing a concept-based method for searching text information. The ontology module 310 can interact with the NLP module 308 to transform a natural language query into predicate structures representing logical relationships between words in the natural language query. The ontology module 310 can comprise one or more ontologies and/or thesauri containing lexical semantic information about words and can be configured for ranking a net of matching natural language query predicate structures and equivalent textual information predicate structures. The ontology module 310 can provide a logical representation and/or a semantic representation for all of the content in an electronic document. In an aspect, such a logical representation and/or a semantic representation can be referred to herein as a data profile. A thesaurus is a structured controlled vocabulary. The thesaurus provides information about each term and its relationships to other terms within the same thesaurus. In addition to specifying which terms can be used as synonyms (called “used from”), a thesaurus also indicates which terms are more specific (narrower terms), which are broader, and which are related terms. An ontology is set of concepts with attributes and relationships between the various concepts that contain various meanings, all to define a domain of knowledge, and is expressed in a format that is machine-readable. Certain applications of ontologies, as used in artificial intelligence or biomedical informatics, can define a domain of knowledge through terms and relationships. In the area of taxonomies and information science, however, an ontology can be seen as a more complex type of thesaurus, in which instead of having simply “related term” relationships, there are various customized relationship pairs that contain specific meaning, such as “owns” and a reciprocal “is owned by.” By way of example, a state of being construct that identifies a user as adhering to Jainism as a religion, can use an ontology to identify terms/concepts related to Jainism, such as vegetarian dietary preferences, and supplement or otherwise utilize the identified terms/concepts to produce search results.

The ontology module 310 can generate one or more data profiles, optionally in conjunction with the NLP module 308. A data profile can comprise a list of concepts and/or terms and their associated relevance weights. A weight can indicate an importance of a concept/term with regard to other concepts/terms. The weights can represent, for example, the frequency with which the concepts occur in textual information, the specificity of the concepts, statistical characteristics of each concept, and the like. Statistical characteristics of concepts can include, without limitation, the specificity, the sensitivity, the number of alternatives occurring in the textual information, the textual similarity, and the like. In one aspect, if a data profile is to be displayed to a user, these weights can be used to determine which concepts from a data profile are shown to the user.

The ontology module 310 and/or the NLP module 308 can determine a weight for a concept/term in a data profile by calculating the number of occurrences frequency) of all concepts/terms. For example, if concept A occurs ten times in a document and concept B occurs five times in the document, the frequency of Concept A can be “normalized” to 100% ((10/10)*100%) and Concept B can be “normalized” to 50% ((5/10)*100%). The following equation can be used for normalization: (frequency/maxfrequency)*100%. A correction algorithm can reduce the weight of concepts that occur in many documents. For example, if a cooking web site is indexed, a very generic term like “heat” will not be very informative while a term like “sous-vide” is very specific. Therefore, if the frequency of the concept “heat” in a document is higher than the frequency of the concept “sous-vide” the concept “sous-vide” would have higher weight after correction.

In an aspect, the ontology module 310 and/or the NLP module 308 can generate a data profile based on search query and/or a state of being construct. The resulting data profile can be used to identify one or more search results based on a comparison between a query data profile and data profiles of potential search results. For example, an amount of overlap between the query data profile and the data profiles of potential search results can identify relevant search results. Determining an overlap of data profiles among a plurality of data profiles can comprise determining a number of concepts that data profiles have in common. In another aspect, a similarity score can be generated that reflects the similarity between a query data profile and the data profiles of potential search results. Determining a similarity score amongst a plurality of data profiles can comprise performing a matching algorithm. Performing a matching algorithm can comprise storing each data profiles as a vector and performing a vector matching algorithm. In one exemplary aspect, a data profile can be stored mathematically as a vector with values between 0 and 1. In this aspect, the matching of a query data profile with a stored data profile can be accomplished via vector matching. As one skilled in the art will appreciate, a variety of algorithms known in the art can be used to calculate the distance between the vectors. In a further aspect, the various algorithms for determining the distance between vectors can comprise, but are not limited to, Vector algorithm, Portal algorithm, Quadsum algorithm, Jaccard algorithm, Dice algorithm, Basic algorithm, Weighted algorithm, Orion algorithm, Weighted Overlap algorithm, and the like. It is contemplated that one or more of these algorithms can be used concurrently.

The search engine index 312 can be a database listing comprising, for example, electronic documents, electronic document metadata, and the like, referred to herein as search results. The search engine index 312 can be configured to maintain a listing of data profiles and/or state of being constructs. Searching the search engine index 312 can utilize metadata. For example, the search engine index 312 by metadata can comprise performing a Boolean search. Searching the search engine index 312 by metadata can comprise performing a search by determining a deviation of a metadata value from a specified value and expressing the deviation in a relevance score. Searching the search engine index 312 by vector matching can comprise storing each data profile as a vector and performing a vector matching algorithm. Searching the search engine index 312 by metadata and by vector matching can be performed simultaneously. Searching the search engine index 312 by metadata and by vector matching can be performed sequentially.

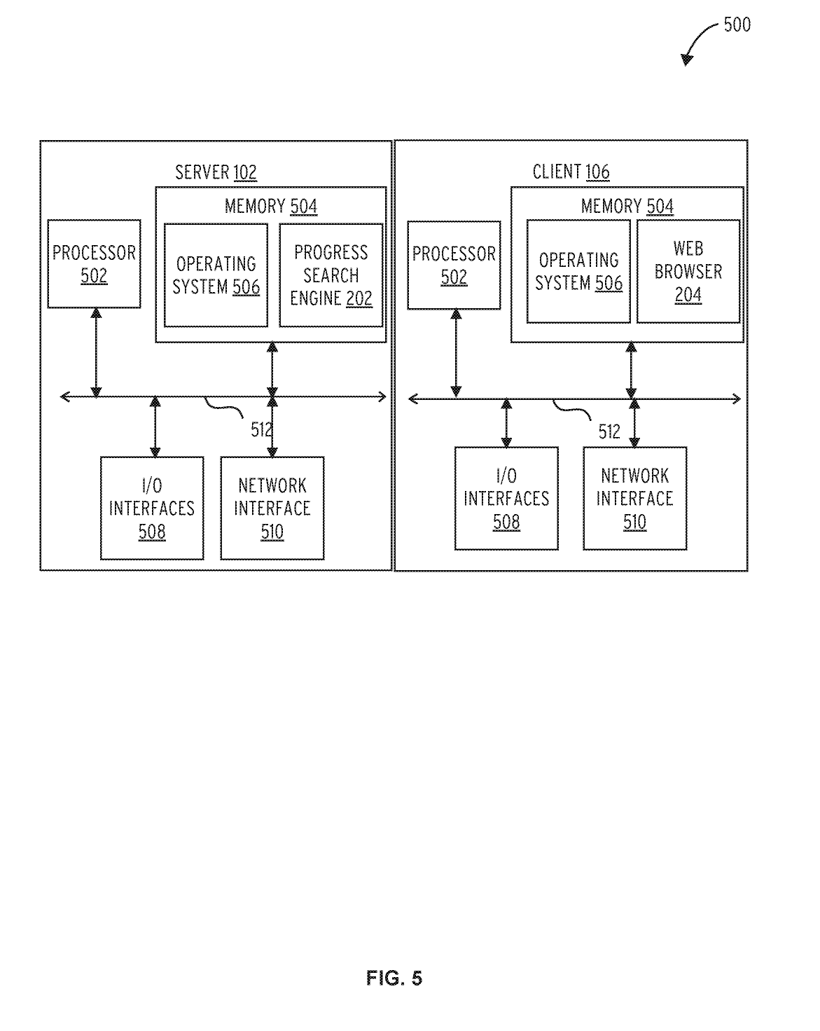

FIG. 5 is a block diagram depicting an environment 500 comprising non-limiting examples of a server 102 and a client 106 according to an aspect. The server 102 and the client 106 can be a digital computer that, in terms of hardware architecture, generally includes a processor 502, memory system 504, input/output (I/O) interfaces 508, and network interfaces 510. These components (502, 504, 508, and 510) are communicatively coupled via a local interface 512. The local interface 512 can be, for example but not limited to, one or more buses or other wired or wireless connections, as is known in the art. The local interface 512 can have additional elements, which are omitted for simplicity, such as controllers, buffers caches), drivers, repeaters, and receivers, to enable communications. Further, the local interface may include address, control, and/or data connections to enable appropriate communications among the aforementioned components.

The processor 502 can be a hardware device for executing software, particularly that stored in memory system 504. The processor 502 can be any custom made or commercially available processor, a central processing unit (CPU), an auxiliary processor among several processors associated with the server 102 and the client 106, a semiconductor-based microprocessor (in the form of a microchip or chip set), or generally any device for executing software instructions. When the server 102 or the client 106 is in operation, the processor 502 can be configured to execute software stored within the memory system 504, to communicate data to and from the memory system 504, and to generally control operations of the server 102 and the client 106 pursuant to the software.

The i/o interfaces 508 can be used to receive user input from and/or for providing system output to one or more devices or components. User input can be provided via, for example, a keyboard and/or a mouse. System output can be provided via a display device and a printer (not shown). i/o interfaces 508 can include, for example, a serial port, a parallel port, a Small Computer System Interface (SCSI), an IR interface, an RF interface, and/or a universal serial bus (USB) interface.

The network interface 510 can be used to transmit and receive from an external server 102 or a client 106 on a network 104. The network interface 510 may include, for example, a 10BaseT Ethernet Adaptor, a 100BaseT Ethernet Adaptor, a LAN PHY Ethernet Adaptor, a Token Ring Adaptor, or any other suitable network interface device. The network interface 510 may include address, control, and/or data connections to enable appropriate communications on the network 104.

The memory system 504 can include any one or combination of volatile memory elements (e.g., random access memory (RAM, such as DRAM, SRAM, SDRAM, etc.)) and nonvolatile memory elements (e.g., ROM, hard drive, tape, CDROM, DVDROM, etc.). Moreover, the memory system 504 may incorporate electronic, magnetic, optical, and/or other types of storage media. Note that the memory system 504 can have a distributed architecture, where various components are situated remote from one another, but can be accessed by the processor 502.

The software in memory system 504 may include one or more software programs, each of which comprises an ordered listing of executable instructions for implementing logical functions. In the example of FIG. 5, the software in the memory system 504 can comprise the progress search engine 202 and a suitable operating system (O/S) 506. In the example of FIG. 5, the software in the memory system 504 comprises a web browser 204 and a suitable operating system (O/S) 506. The Operating system 506 essentially controls the execution of other computer programs, such as the search engine 202, the web browser 204, and provides scheduling, input-output control, file and data management, memory management, and communication control and related services.

The progress search engine 202 can be used for providing search results responsive to a search term provided by a user. In an aspect, the search term can be one or more keywords, a phrase, a question, a natural language query, a concept, combinations thereof, and the like. A search result can comprise a web site or any other electronic file. The present description will refer to web sites for simplicity. A web site can reside on a network 104 (e.g., Internet) and can be a collection of one or more web pages, which are electronic documents that can be coded, for example, in HTML that are linked to each other and very often to pages on other web sites. A web site can be hosted on a website owner's server or on an ISP's (Internet Service Providers) server. A web site may share space on a server with other web sites, reside on a server 102 dedicated to that web site only, or be on multiple dedicated servers 102. A web page may contain a variety of information such as, for example, weather, sports, news, financial information, or any other information. Additionally, a web page can provide commercial transactions to users such as, for example, selling books, trading items, reserving travel information, or any other commercial transaction. The progress search engine 202 can be configured to search for web pages or any other electronic file. The progress search engine 202 can comprise one or multiple databases of web pages. The progress search engine 202 can use one or more algorithms to store and retrieve relevant search results in the database(s) responsive to the search term. For example, the database(s) may index the web pages according to keywords for subsequent searches. The progress search engine 202 can comprise an updating algorithm to regularly search the Internet for new or updated web pages. The progress search engine 202 can be configured to operate on one or multiple server(s) 102.

The progress search engine 202 can be configured to determine one or more of a domain-level link feature, a page-level link feature, a page-level keyword feature, a page-level content-based feature, a page-level keyword-agnostic feature, engagement data, traffic/query data, domain-level brand metrics, domain-level keyword usage, domain-level keyword-agnostic feature, page-level social metrics, and combinations thereof The progress search engine 202 can utilize such features to determine a relevance of a potential search result (e.g., web site). The domain-level link feature can be based on link/citation metrics such as quantity of links, trust, domain-level PageRank, etc. . . . The page-level link feature can be based on PageRank, trust metrics, quantity of linking root domains, links, anchor text distribution, quality/“spamminess” of linking resources, etc. . . . The page-level keyword feature and/or the page-level content-based feature can be based on content relevance scoring, on-page optimization of keyword usage, topic-modeling algorithm scores on content, content quantity/quality/relevance, etc. . . . The page-level keyword-agnostic feature can be based on content length, readability, Open Graph markup, uniqueness, load speed, structured data markup, HTTPS, etc. . . . The engagement data and/or the traffic/query data can comprise data SERP engagement metrics, clickstream data, visitor traffic/usage signals, quantity/diversity/CTR of queries, both on the domain and the page level. The domain-level brand metrics can be based on offline usage of brand/domain name, mentions of brand/domain in news/media/press, toolbar/browser data of site usage, entity association, etc. . . . The domain-level keyword usage can be based on exact-match keyword domains, partial-keyword matches, etc. . . . The domain-level keyword-agnostic feature can be based on domain name length, TLD extension, SSL certificate, etc. . . . The page-level social metrics can be based on quantity/quality of tweeted links, Facebook shares, Google +1s, etc. . . . , to the page.

The progress search engine 202 can be configured to determine a similarity between a data profile of a state of being construct to a data profile of one or more search results. The progress search engine 202 can be configured to identify which of a set of search results comprises a keyword in common with a domain of a state of being construct. The progress search engine 202 can be configured to determine a relevance of a set of search results to one or more keywords or concepts that comprise a domain of a state of being construct.

A web browser 204 can be used to view web pages on a client 106. The web pages may reside on a network 104 (e.g., Internet) or on a local computer. A web browser 204 can be configured to view a web page responsive to an input from a user. The input can be a URL (Uniform Resource Locator) address input directly into the web browser or a hyperlink on a currently viewed web page. Examples of commonly used web browsers include Google Chrome, Microsoft Internet Explorer, Netscape Navigator, and Mozilla FireFox.

The progress search engine 202 and/or the web browser 204 can be a source program, an executable program (object code), a script, or any other entity comprising a set of instructions to be performed. When the progress search engine 202 and/or the web browser 204 is a source program, then the progress search engine 202 and/or the web browser 204 can be translated via a compiler, assembler, interpreter, or the like, which may or may not be included within the memory system 504, so as to operate properly in connection with the O/S 506. Furthermore, the progress search engine 202 and/or the web browser 204 can be written as (a) an object oriented programming language, which has classes of data and methods, or (b) a procedure programming language, which has routines, subroutines, and/or functions, such as, for example, but not limited to, C, C++, Pascal, Basic, Fortran, Cobol, Perl, and Java.

When the progress search engine 202 and/or the web browser 204 is implemented in software, it should be noted that the progress search engine 202 and/or the web browser 204 can be stored on any computer readable medium for use by or in connection with any computer related system or method. In the context of this document, a computer readable medium is an electronic, magnetic, optical, or other physical device or means that can contain or store a computer program for use by or in connection with a computer related system or method. The progress search engine 202 and/or the web browser 204 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any non-transitory means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical).

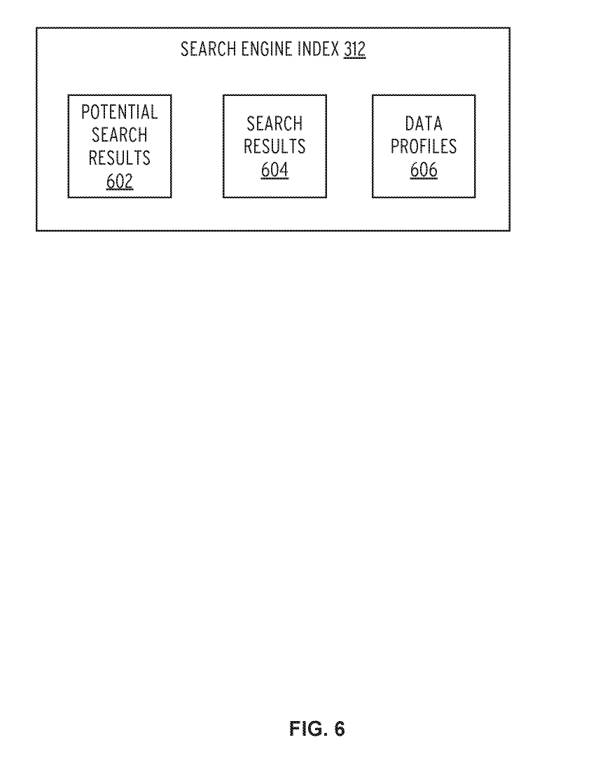

FIG. 6 is block diagram depicting an exemplary view of a search engine index 312 according to an embodiment, among others. The search engine index 312 can comprise potential search results 602, search results 604, and/or data profiles 606. The potential search results 602 can comprise search results that are generated based on a search query, but prior to the application of a state of being construct. In another aspect, the potential search results 602 can comprise all or a portion of a universe of possible search results that have been scanned and/or indexed prior to a search query. In an aspect, the potential search results 602 can comprise one or more tags that provide information regarding the content of the potential search results 602 that can be used by the progress search engine 202 to determine whether the potential search results 602 the potential search results 602 are responsive to a search query in light of a state of being construct. The one or more tags can be generated manually (e.g., by selection by a user) or automatically. The one or more tags can be generated automatically (for example, by the NLP module 308 and/or the ontology module 310) by scanning the content of the potential search results 602 and computationally determining one or more terms and/or concepts that define the content of the potential search results 602. In another aspect, the one or more tags can be generated based on a data profile created by one or more of the NLP module 308 and/or the ontology module 310, as described herein. In one aspect, the one or more tags can be stored as metadata associated with the potential search results 602.

The search results 604 can comprise those potential search results 602 that remain after application of the state of being construct. The search results 604 can comprise organic search results and/or non-organic search results. The organic search results can comprise search results generated based on relevance to the search query and/or applicability of the state of being construct. The non-organic search results can similarly be based on relevance to the search query and/or applicability of the state of being construct, however, the non-organic search results are targeted towards users having a particular state of being construct. The non-organic search results can comprise commercial search results that an advertiser paid to have delivered to a specific user and/or group of users based on the specific user's and/or group of users' state of being constructs. In an aspect, the data profiles 606 can comprise a list of concepts and/or terms found in the potential search results 602 and/or the search results 604 and their associated relevance weights,

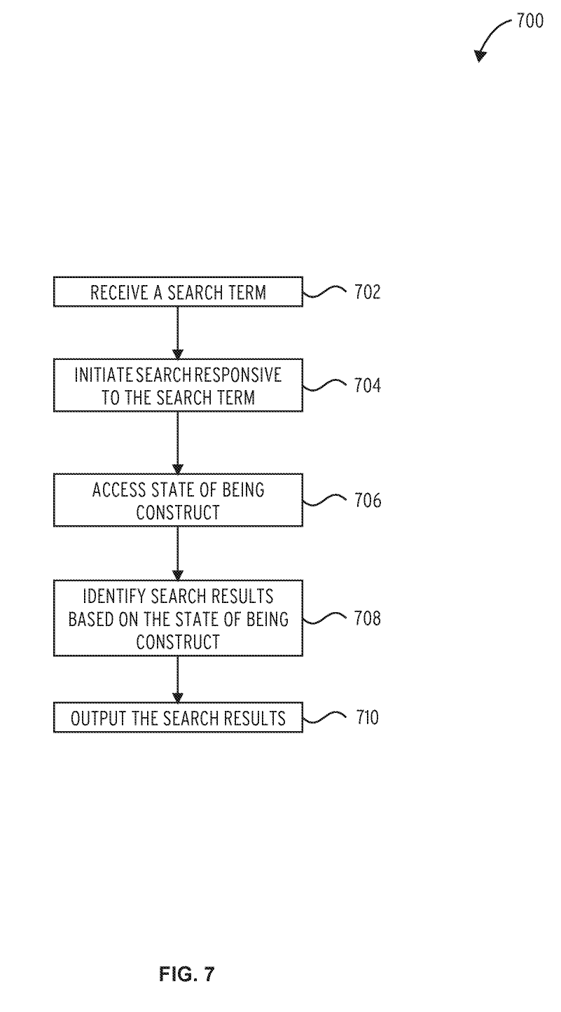

FIG. 7 is a flowchart depicting a general example of a method 700 for providing search results using a progress search engine. A search term is received from a user, as indicated in step 702. For example, a web browser, or similar can be configured to view a progress search engine web page, and a user may input a search term to the search engine via the web browser. A search is initiated responsive to the search term, as indicated in step 704. For example, a search engine may initiate a search of a database responsive to the search term. A state of being construct can be accessed, as indicated in step 704. Search results are identified based on the state of being construct, as indicated in step 706. The search results are outputted to an output device, as indicated in step 708.

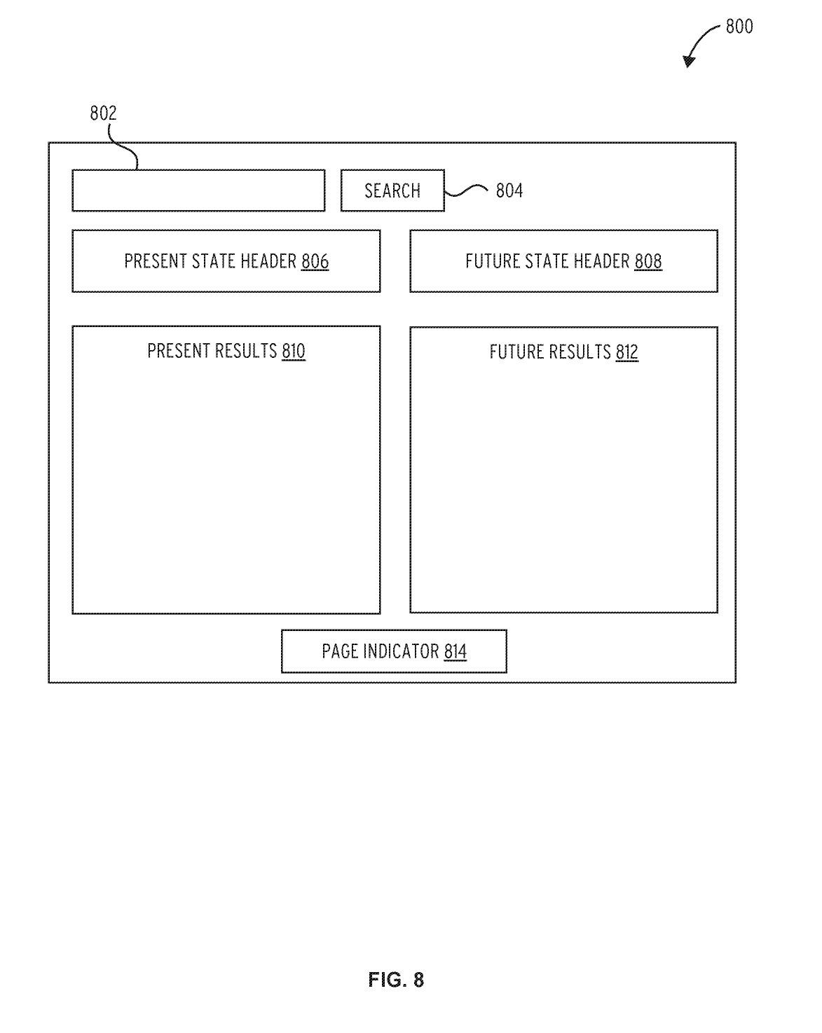

FIG. 8 is a schematic diagram depicting an example of web browser screen 800 showing search results generated based on a state of being construct. The web browser screen 800 can comprise a search box 802, a search button 804, a present state header 806, a future state header 808, present results 810, future results 812, and a page indicator 814. A user inputs a search term in the search box 802 and initiates a search by clicking on the search button 804. A progress search engine can provide the present results 810 and the future results 812 in separate, adjacent columns. In an aspect, the progress search engine can be configured to only deliver the present results 810 or the future results 812. The present state header 806 and the future state header 808 provide the user with the number of results found by the search engine. The present results 810 and the future results 812 comprise web page links which the user may click on to visit the web page. The page indicator 814 provides the user with the current page of search results and a link to go to the next or the previous page of search results.

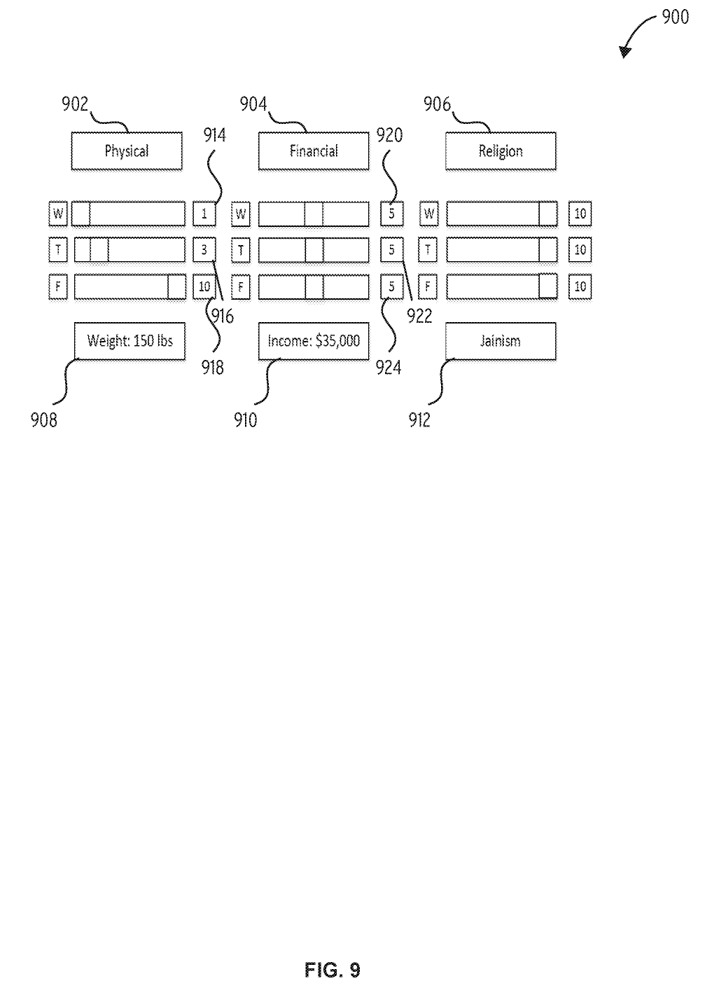

An example state of being construct 900 is illustrated in FIG. 9 can be used to indicate how the progress search engine generates the present results 810 and the future results 812. The state of being construct 900 can comprise three domains, a physical health domain 902, a financial domain 904, and a religion domain 906. The physical health domain 902 can comprise user data related to a user's physical health, for example, height, weight, blood pressure, diseases, prescriptions, etc. The physical health domain 902 in the state of being construct 900 comprises a weight 908 with a value of 150 pounds. As the state of being construct 900 reflects a version of a user's future self, the value of 150 pounds represents the amount the user wants/expects to weigh at some point in the future. The financial domain 904 can comprise user data related to a user's finances, for example, income, investments, assets, debts, etc. The financial domain 904 in the state of being construct 900 comprises an income 910 with a value of $35,000. As the state of being construct 900 reflects a version of a user's future self, the value of $35,000 represents the income the user wants/expects to earn at some point in the future. The religion domain 906 can comprise user data related to a user's religion, for example, name of religion, position with the religion, branch/sect of the religion, etc. The religion domain 906 in the state of being construct 900 comprises an identification of religion 912 with a value of Jainism. As the state of being construct 900 reflects aversion of a user's future self, the value of Jainism represents the religion the user wants/expects to follow at some point in the future.

The state of being construct 900 can comprise a weight assigned to the user data in the various domains. The weight assigned to the user data reflects how much that user data should be taken into account when determining search results. The state of being construct 900 can comprise a time component for the user data that comprises a value indicative of an amount of time a user is willing to dedicate. For example, the user can indicate that user data within a domain is associated with a particular time frame (e.g., a value of 1 can represent a short amount of time whereas a value of 10 can represent a long amount of time). The state of being construct 900 can comprise a force component for the user data that comprises a value indicative of a level of effort required by a user. For example, the user can indicate how committed the user is to the user data within a domain (e.g., a value of 1 can represent that the user is not very committed whereas a value of 10 can represent that the user is very committed). In the state of being construct 900, the weight 908 is assigned a weight 914 of “1”, a time component 916 of “3”, and a force component 918 of “10”. Accordingly, the weight 908 is afforded very little weight, the user has a relatively small amount of time to dedicate, and the user is very dedicated toward achieving the weight 908. In the state of being construct 900, the income 910 is assigned a weight 920 of “5”, a time component 922 of “5”, and a force component 924 of “5”. Accordingly, the income 910 is afforded moderate weight, the user has a moderate amount of time to dedicate, and the user is moderately dedicated toward achieving the income 910, in the state of being construct 900, the identification of religion 912 is assigned a weight 926 of “10”, a time component 928 of “10”, and a force component 930 of “10”. Accordingly, the identification of religion 912 is afforded significant weight, the user has a long amount of time to dedicate, and the user is very dedicated toward identification of religion 912.

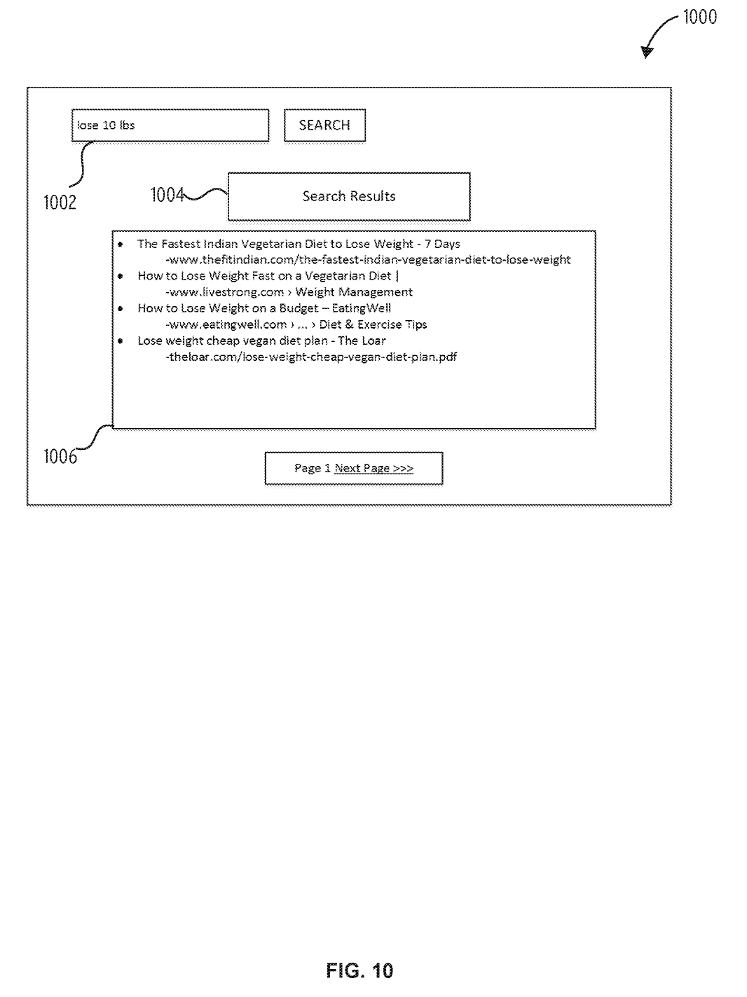

FIG. 10 illustrates a web browser screen 1000 with a non-limiting example of a search of a keyword ‘lose 10 lbs’ in a search box 1002. A future search results header 1004 is affixed above future search results 1006. The web browser screen 1000 illustrates an example of search results based on the state of being construct 900 provided in FIG. 9. For example, the future search results 1006 for ‘lose 10 lbs’ can comprise “The Fastest Indian Vegetarian Diet to Lose Weight—7 Days,” “How to Lose Weight Fast on a Vegetarian Diet,” “How to Lose Weight on a Budget—EatingWell,” and “Lose weight cheap vegan diet plan,” among others. The future search results 1006 reveal that the search identified that the state of being construct 900 indicated that the user adheres to Jainism, whose followers follow a vegetarian diet, thus the future search results 1006 contain weight loss websites that are related to vegetarian diets. The future search results 1006 reveal that the search identified that the state of being construct 900 indicated that the user makes $35,000 and thus the future search results 1006 contain websites related to weight loss that are for a moderate budget. Finally, the future search results 1006 reveal that the search identified that the state of being construct 900 indicated that the user has a short amount of time to attain the desired weight of 150 lbs. Accordingly, the future search results 1006 contain websites related to weight loss that can be accomplished quickly. A search conducted without the state of being construct 900 would have identified websites that might not have adhered to the user's diet, budget, and/or timing.

In an aspect, the state of being construct 900 can be modified after the search has been conducted to modify the future search results 1006. For example, the time component 916 of “3” for the weight 908 could be modified post-search to a “10.” The result would be to identify search results that do not necessarily have to be directed to quick weight loss. Any aspect of a state of being construct can be modified post-search to allow a user to adjust the search results and fine tune the search results to the user's liking. For example, a user can add/delete a domain, add/delete user data contained within a domain, modify a weight of a domain and/or user data, modify a time component of a domain and/or user data, modify a force component of a domain and/or user data, combinations thereof, and the like.

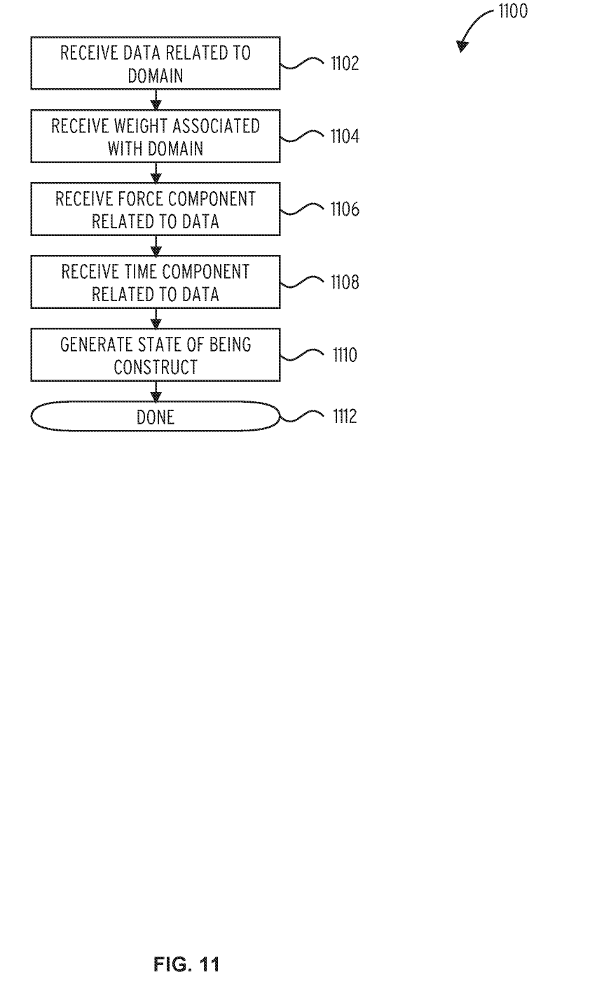

In an aspect, illustrated in FIG. 11, provided is a method 1100 comprising, in block 1102, method 1100 receives data related to a domain. In block 1104, method 1100 receives a weight associated with the domain. In block 1106, method 1100 receives a force component related to the data. In block 1108, method 1100 receives a time component related to the data. In block 1110, method 1100 generates a state of being construct based on the data, the domain, the weight, the force component, and the time component. In block 1112, method 1100 ends. In some embodiments, the data may include information related to a user at a present state. In some embodiments, the data may include information related to a user at a future state. In some embodiments, the domain may include a religion domain, a politics domain, a financial domain, a geographic domain, a racial domain, a physical health domain, and a mental health domain. In some embodiments, the weight may include a value indicative of an importance of the domain. In some embodiments, the force component may include a value indicative of a level of effort required by a user. In some embodiments, the time component may include a value indicative of an amount of time a user is willing to dedicate. In some embodiments, the state of being construct may include a data structure configured for filtering one or more search results and/or one or more search queries.

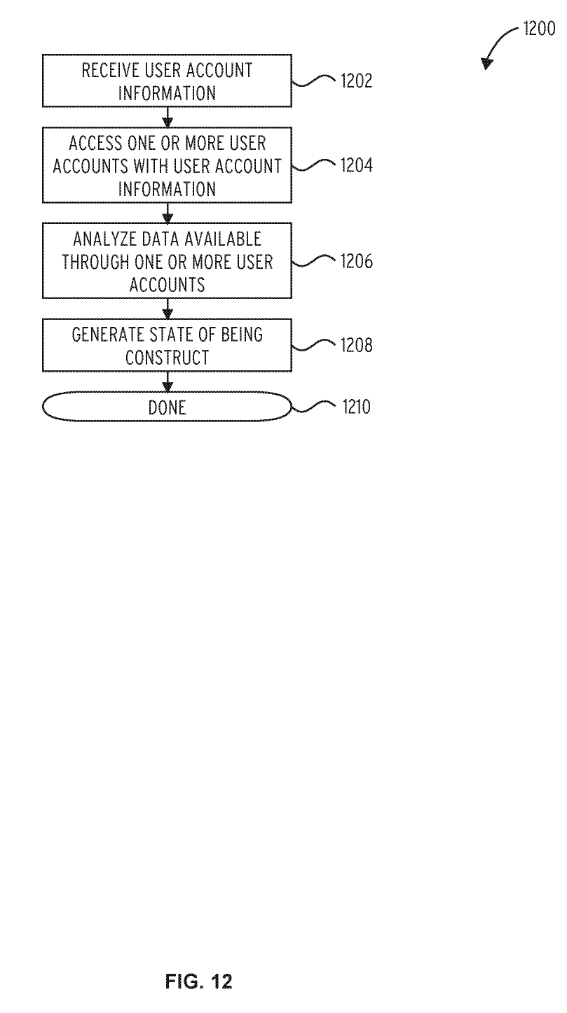

In an aspect, illustrated in FIG. 12, provided is a method 1200 comprising in block 1202, method 1200 receives user account information. In block 1204, method 1200 accesses one or more user accounts with the user account information. In block 1206, method 1200 analyzes data available through the one or more user accounts. In block 1208, method 1200 generates a state of being construct. In block 1210, method 1200 ends.

In some embodiments, analyzing data available through the one or more user accounts may include classifying the data into a plurality of domains and/or assigning a weight to each of the plurality of domains. In some embodiments, such a method may further include receiving a force component related to the data and/or receiving a time component related to the data.

In some embodiments, the data may include information related to a user at a present state. In some embodiments, the data may include information related to a user at a future state. In some embodiments, the plurality of domains may include a religion domain, a politics domain, a financial domain, a geographic domain, a racial domain, a physical health domain, and a mental health domain.

In some embodiments, the weight may include a value indicative of an importance of the domain. In some embodiments, the force component may include a value indicative of a level of effort required by a user. In some embodiments, the time component may include a value indicative of an amount of time a user is willing to dedicate. In some embodiments, the state of being construct may include a data structure configured for filtering one or more search results and/or one or more search queries.

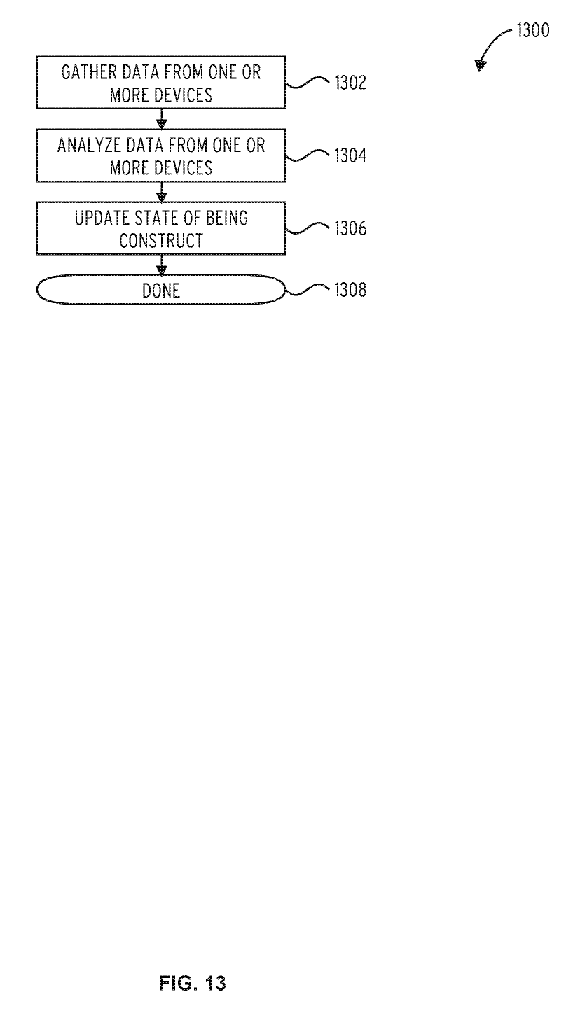

In an aspect, illustrated in FIG. 13, provided is a method 1300 comprising in block 1302, method 1300 gathers data from one or more devices. In block 1304, method 1300 analyzes the data from the one or more devices. In block 1306, method 1300 updates a state of being construct. In block 1308, method 1300 ends. In some embodiments, the data may include information related to a user at a present state. In some embodiments, the data may include information related to a user at a future state. In some embodiments, the one or more devices may include one or more of, a smart watch, a smart phone, a tablet, a laptop, a desktop, a server, a vaping device, a heart monitor, a fitness tracker, and combinations thereof. In some embodiments, gathering the data from the one or more devices may include receiving the data via a Bluetooth, and/or cellular connection. In some embodiments, the state of being construct may include a data structure configured for filtering one or more search results and/or one or more search queries.

In some embodiments, analyzing the data from the one or more devices may include classifying the data into a plurality of domains and/or assigning a weight to each of the plurality of domains. In some embodiments, the weight may include a value indicative of an importance of the domain. In some embodiments, the plurality of domains may include a religion domain, a politics domain, a financial domain, a geographic domain, a racial domain, a physical health domain, and a mental health domain. In some embodiments, such a method may further include receiving a force component related to the data and/or receiving a time component related to the data. In some embodiments, the time component may include a value indicative of an amount of time a user is willing to dedicate. In some embodiments, the force component may include a value indicative of a level of effort required by a user.

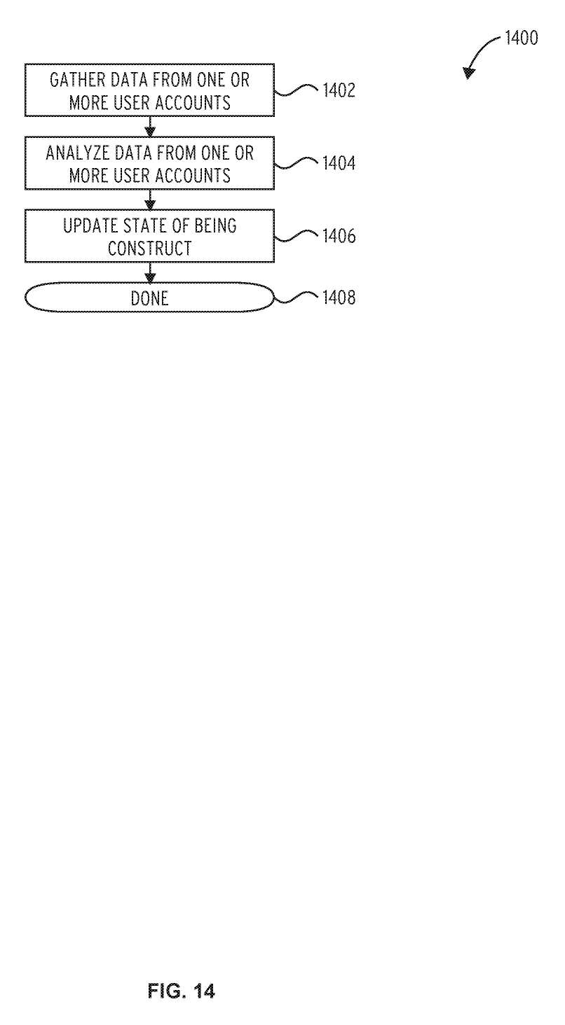

In an aspect, illustrated in FIG. 14, provided is a method 1400 comprising in block 1402, method 1400 gathers data from one or more user accounts. In block 1404, method 1400 analyzes the data from the one or more user accounts. In block 1406, method 1400 updates a state of being construct. In block 1408, method 1400 ends. In some embodiments, the data may include information related to a user at a present state. In some embodiments, the data may include information related to a user at a future state. In some embodiments, the state of being construct may include a data structure configured for filtering one or more search results and/or one or more search queries. In some embodiments, gathering the data from the one or more user accounts may include receiving the data via a Bluetooth, Wi-Fi, and/or cellular connection.

In some embodiments, the one or more user accounts may include one or more of, a Facebook account, a Twitter account, a Pinterest account, a Myspace account, a Google Plus account, and combinations thereof. In some embodiments, analyzing the data from the one or more user accounts may include classifying the data into a plurality of domains and/or assigning a weight to each of the plurality of domains. In some embodiments, the weight may include a value indicative of an importance of the domain. In some embodiments, the plurality of domains may include a religion domain, a politics domain, a financial domain, a geographic domain, a racial domain, a physical health domain, and a mental health domain. In some embodiments, such a method may further include receiving a force component related to the data and/or receiving a time component related to the data. In some embodiments, the time component may include a value indicative of an amount of time a user is willing to dedicate. In some embodiments, the force component may include a value indicative of a level of effort required by a user.

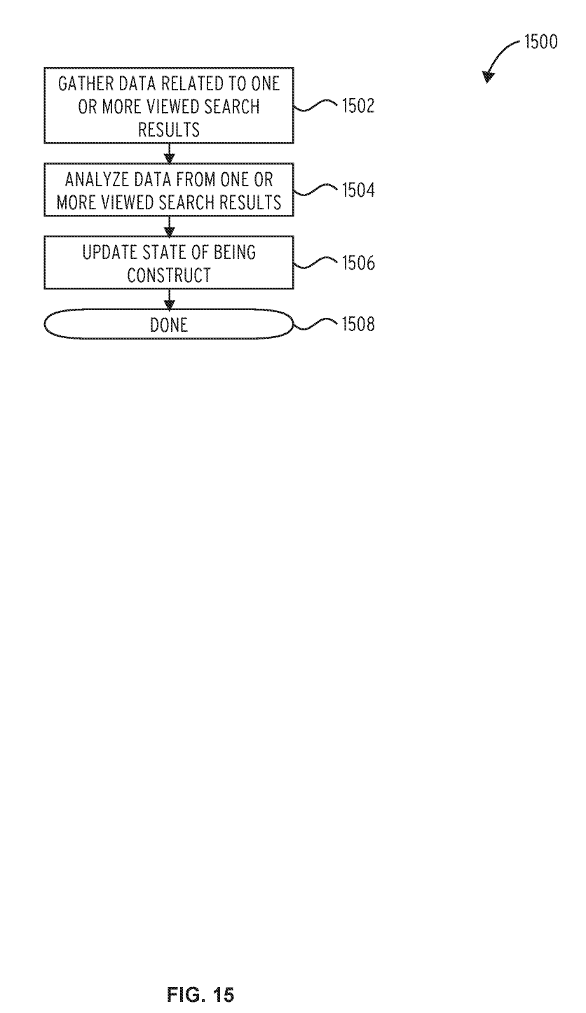

In an aspect, illustrated in FIG. 15, provided is a method 1500 comprising in block 1502, method 1500 gathers data related to one or more viewed search results. In block 1504, method 1500 analyzes the data from the one or more viewed search results. In block 1506, method 1500 updates a state of being construct. In block 1508, method 1500 ends. In some embodiments, the data may include information related to a user at a present state. In some embodiments, the data may include information related to a user at a future state. In some embodiments, the state of being construct may include a data structure configured for filtering one or more search results and/or one or more search queries. In some embodiments, gathering the data related to the one or more viewed search results may include receiving the data via a Bluetooth, Wi-Fi, and/or cellular connection.

In some embodiments, the one or more viewed search results may include one or more of, Google search results, Bing search results, Yahoo! search results, and combinations thereof. In some embodiments, analyzing the data from the one or more viewed search results may include classifying the data into a plurality of domains and/or assigning a weight to each of the plurality of domains. In some embodiments, the weight may include a value indicative of an importance of the domain. In some embodiments, the plurality of domains may include a religion domain, a politics domain, a financial domain, a geographic domain, a racial domain, a physical health domain, and a mental health domain. In some embodiments, such a method may further include receiving a force component related to the data and/or receiving a time component related to the data. In some embodiments, the time component may include a value indicative of an amount of time a user is willing to dedicate. In some embodiments, the force component may include a value indicative of a level of effort required by a user.

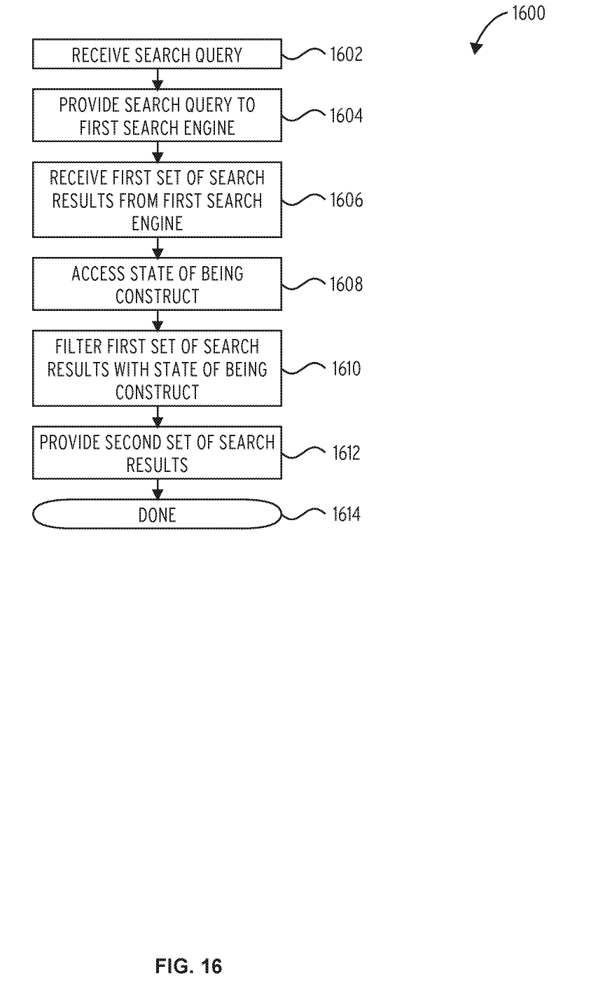

In an aspect, illustrated in FIG. 16, provided is a method 1600 comprising in block 1602, method 1600 receives a search query. In block 1604, method 1600 provides the search query to a first search engine. In block 1606, method 1600 receives a first set of search results from the first search engine. In block 1608, method 1600 accesses a state of being construct. In block 1610, method 1600 filters the first set of search results with the state of being construct to generate a second set of search results. In block 1612, method 1600 provides the second set of search results. In block 1614, method 1600 ends.

In some embodiments, a method may include receiving a search query, providing the search query to a first search engine, receiving a first set of search results from the first search engine, accessing a state of being construct, filtering the first set of search results with the state of being construct to generate a second set of search results, and/or providing the second set of search results. In some embodiments, receiving the search query may include receiving one or more keywords. In some embodiments, providing the search query to the first search engine may include passing the search query to the first search engine via a hypertext transfer protocol. In some embodiments, receiving the first set of search results from the first search engine may include receiving the first set of search results via a hypertext transfer protocol. In some embodiments, the state of being construct may include a data structure configured for filtering the first set of search results.

In some embodiments, the state of being construct may include data relating to a plurality of domains. In some embodiments, the plurality of domains may include a religion domain, a politics domain, a financial domain, a geographic domain, a racial domain, a physical health domain, and a mental health domain. In some embodiments, each of the plurality of domains may include a weight. In some embodiments, the data may include information related to a user at a present state. In some embodiments, the data may include information related to a user at a future state.

In some embodiments, the data may include a force component and a time component. In some embodiments, the force component may include a value indicative of a level of effort required by a user. In some embodiments, the time component may include a value indicative of an amount of time a user is willing to dedicate.

In some embodiments, filtering the first set of search results with the state of being construct may include determining a similarity between a data profile of the state of being construct to a data profile of each of the first set of search results. In some embodiments, filtering the first set of search results with the state of being construct may include identifying which of the first set of search results comprise a keyword in common with a domain of the state of being construct. In some embodiments, filtering the first set of search results with the state of being construct may include determining a relevance of the first set of search results to one or more keywords or concepts that comprise a domain of the state of being construct.

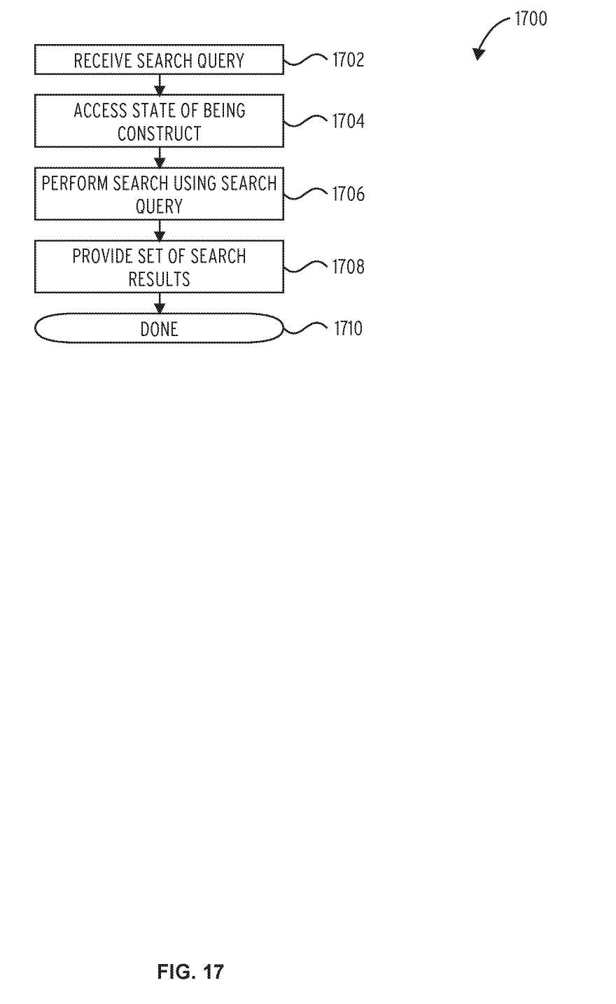

In an aspect, illustrated in FIG. 17, provided is a method 1700 comprising in block 1702, method 1700 receives a search query. In block 1704, method 1700 accesses a state of being construct. In block 1706, method 1700 performs a search using the search query and the state of being construct to generate a set of search results. In block 1708, method 1700 provides the set of search results. In block 1710, method 1700 ends.

In some embodiments, a method may include receiving a search query, accessing a state of being construct, performing a search using the search query and the state of being construct to generate a set of search results, and/or providing the set of search results. In some embodiments, receiving a search query may include receiving one or more keywords. In some embodiments, receiving a search query may include receiving the search query via a hypertext transfer protocol. In some embodiments, the state of being construct may include a data structure configured for filtering the set of search results.

In some embodiments, the state of being construct may include data relating to a plurality of domains. In some embodiments, the plurality of domains may include a religion domain, a politics domain, a financial domain, a geographic domain, a racial domain, a physical health domain, and a mental health domain. In some embodiments, each of the plurality of domains may include a weight. In some embodiments, the data may include information related to a user at a present state. In some embodiments, the data may include information related to a user at a future state. In some embodiments, the data may include a force component and a time component. In some embodiments, the force component may include a value indicative of a level of effort required by a user. In some embodiments, the time component may include a value indicative of an amount of time a user is willing to dedicate.

In some embodiments, performing a search using the search query and the state of being construct to generate a set of search results may include identifying one or more search results that include the search query. In some embodiments, performing a search using the search query and the state of being construct to generate a set of search results may include determining one or more of a domain-level link feature, a page-level link feature, a page-level keyword feature, a page-level content-based feature, a page-level keyword-agnostic feature, engagement data, traffic/query data, domain-level brand metrics, domain-level keyword usage, domain-level keyword-agnostic feature, page-level social metrics, and combinations thereof.

In some embodiments, performing a search using the search query and the state of being construct to generate a set of search results may include determining a similarity between a data profile of the state of being construct to a data profile of each of the set of search results. In some embodiments, performing a search using the search query and the state of being construct to generate a set of search results may include identifying which of the set of search results comprise a keyword in common with a domain of the state of being construct. In some embodiments, performing a search using the search query and the state of being construct to generate a set of search results may include determining a relevance of the set of search results to one or more keywords or concepts that comprise a domain of the state of being construct.

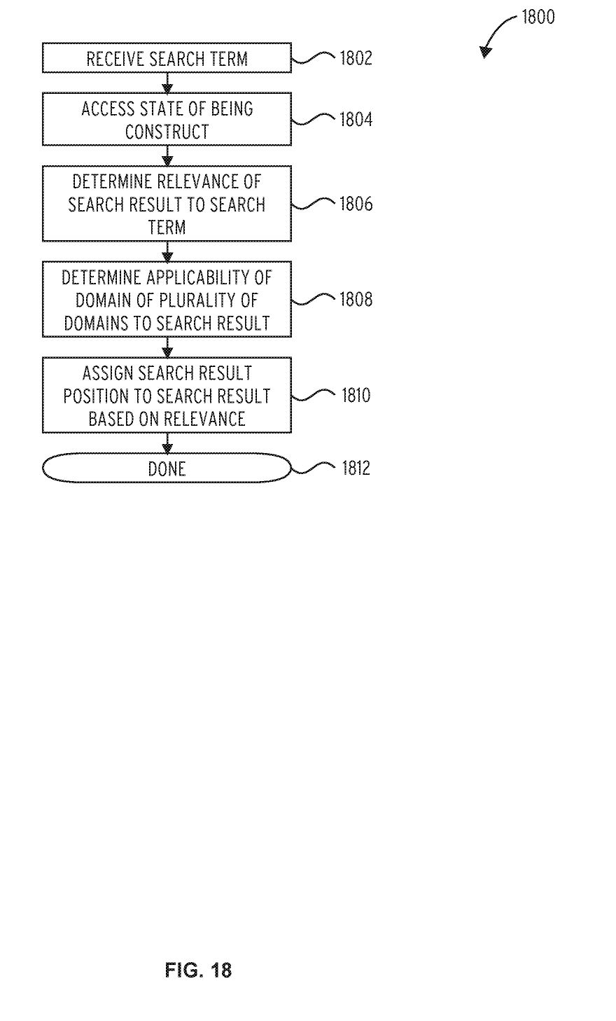

In an aspect, illustrated in FIG. 18, provided is a method 1800 comprising in block 1802, method 1800 receives a search term. In block 1804, method 1800 accesses a state of being construct wherein the state of being construct comprises user data in a plurality of domains. In block 1806, method 1800 determines a relevance of a search result to the search term. In block 1808, method 1800 determines an applicability of a domain of the plurality of domains to the search result. In block 1810, method 1800 assigns a search result position to the search result based on the relevance. In block 1812, method 1800 ends.

In some embodiments, a method may include receiving a search term, accessing a state of being construct wherein the state of being construct comprises user data in a plurality of domains, determining a relevance of a search result to the search term, determining an applicability of a domain of the plurality of domains to the search result, and/or assigning a search result position to the search result based on the relevance and the applicability.

In some embodiments, the state of being construct may include user data in a plurality of domains. In some embodiments, the user data may include information related to a user at a present state. In some embodiments, the user data may include information related to a user at a future state. In some embodiments, the plurality of domains may include a religion domain, a politics domain, a financial domain, a geographic domain, a racial domain, a physical health domain, and a mental health domain.

In some embodiments, determining a relevance of a search result to the search term may include identifying one or more search results that may include the search term.

In some embodiments, determining a relevance of a search result to the search term may include determining one or more of a domain-level link feature, a page-level link feature, a page-level keyword feature, a page-level content-based feature, a page-level keyword-agnostic feature, engagement data, traffic/query data, domain-level brand metrics, domain-level keyword usage, domain-level keyword-agnostic feature, page-level social metrics, and combinations thereof.

In some embodiments, determining a relevance of a search result to the search term may include identifying a subset of the one or more search results that are popular with a plurality of users having a similar future state.

In some embodiments, the method determining an applicability of a domain of the plurality of domains to the search result may include determining a similarity between the s a e of being construct and a plurality of state of being constructs and determining if the search result was previously consumed by one or more of the plurality of state of being constructs determined to be similar to the state of being construct.

In some embodiments, determining an applicability of a domain of the plurality of domains to the search result may include determining a relevance of the search result to one or more keywords or concepts that comprise the domain of the plurality of domains.

In some embodiments, determining a relevance of the search result to one or more keywords or concepts that may include determining one or more of a domain-level link feature, a page-level link feature, a page-level keyword feature, a page-level content-based feature, a page-level keyword-agnostic feature, engagement data, traffic/query data, domain-level brand metrics, domain-level keyword usage, domain-level keyword-agnostic feature, page-level social metrics, and combinations thereof.

In some embodiments, determining a relevance of the search result to one or more keywords or concepts that comprise the domain of the plurality of domains may include generating a first data profile for the search result, generating a second data profile for the domain of the plurality of domains, determining an overlap of the first data profile and the second data profile, and/or identifying the search result is relevant wherein the overlap is above a threshold.

In some embodiments, such a method may further include determining a weight associated with the domain of the plurality of domains. In some embodiments, assigning the search result position to the search result based on the determined relevance and the determined applicability may further include assigning the search result position to the search result based on the determined weight. In some embodiments, such a method may further include providing the search result according to the search result position.

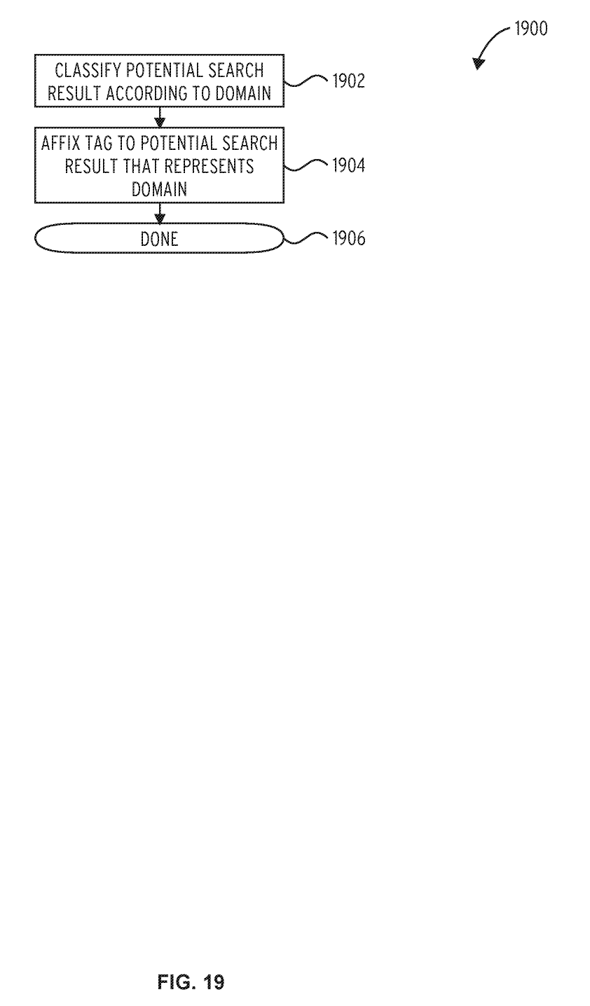

In an aspect, illustrated in FIG. 19, provided is a method 1900 comprising in block 1902, method 1900 classifies a potential search result according to a domain. In block 1904, method 1900 affixes a tag to the potential search result that represents the domain. In block 1906, method 1900 ends.

In some embodiments, a method may include classifying a potential search result according to a domain and/or affixing a tag to the potential search result that represents the domain. In some embodiments, classifying a potential search result according to a domain may include retrieving a domain description, determining a relevance of the potential search result to the domain description, and/or determining that the potential search result should be classified as associated with the domain based on the relevance.

In some embodiments, the domain description may include a list of terms associated with the domain. In some embodiments, determining the relevance of the potential search result to the domain description may include identifying one or more search results that comprises the search term.

In some embodiments, determining the relevance of the potential search result to the domain description may include determining one or more of a domain-level link feature, a page-level link feature, a page-level keyword feature, a page-level content-based feature, a page-level keyword-agnostic feature, engagement data, traffic/query data, domain-level brand metrics, domain-level keyword usage, domain-level keyword-agnostic feature, page-level social metrics, and combinations thereof. In some embodiments, determining the relevance of the potential search result to the domain description may include generating a first data profile for the potential search result, generating a second data profile for the domain, determining an overlap of the first data profile and the second data profile, and/or identifying the potential search result as relevant wherein the overlap is above a threshold.

In some embodiments, determining that the potential search result should be classified as associated with the domain based on the relevance may include determining that the relevance exceeds a threshold. In some embodiments, affixing the tag to the potential search result that represents the domain may include adding, modifying, and/or deleting metadata associated with the potential search result.

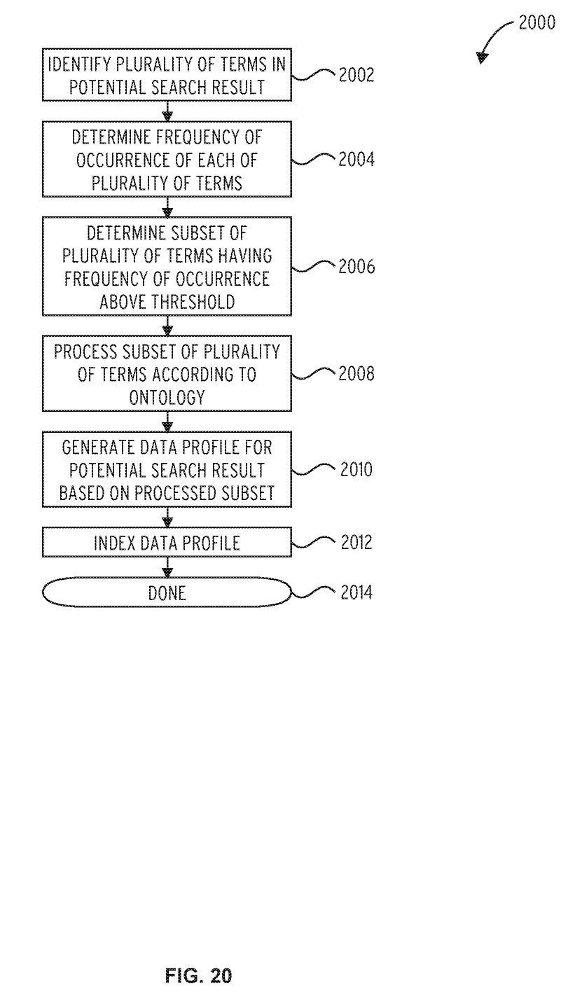

In an aspect, illustrated in FIG. 20, provided is a method 2000 comprising in block 2002, method 2000 identifies a plurality of terms in a potential search result. In block 2004, method 2000 determines a frequency of occurrence of each of the plurality of terms. In block 2006, method 2000 determines a subset of the plurality of terms having a frequency of occurrence above a threshold. In block 2008, method 2000 processes the subset of the plurality of terms according to an ontology. In block 2010, method 2000 generates a data profile for the potential search result based on the processed subset wherein the data profile comprises a plurality of concepts. In block 2012, method 2000 indexes the data profile. In block 2014, method 2000 ends.

In some embodiments, a method may include identifying a plurality of terms in a potential search result, determining a frequency of occurrence of each of the plurality of terms, determining a subset of the plurality of terms having a frequency of occurrence above a threshold, processing the subset of the plurality of terms according to an ontology, generating a data profile for the potential search result based on the processed subset wherein the data profile comprises a plurality of concepts, and/or indexing the data profile. In some embodiments, the ontology may include a list of concepts associated with one or more terms.

In some embodiments, processing the subset of the plurality of terms according to an ontology may include identifying which of the subset of the plurality of terms occur in the ontology and/or associating one or more concepts of the list of concepts with the subset of the plurality of terms identified as occurring in the ontology.

In some embodiments, such a method may further include associating one or more weights with the data profile based on the frequency of occurrence. In some embodiments, indexing the data profile may include associating the data profile with other data profiles based on a similarity determination.

In some embodiments, indexing the data profile may include associating the data profile with one or more domains based on a similarity determination. In some embodiments, the similarity determination is based on a comparison between the data profile and one or more data profiles for one or more domains.

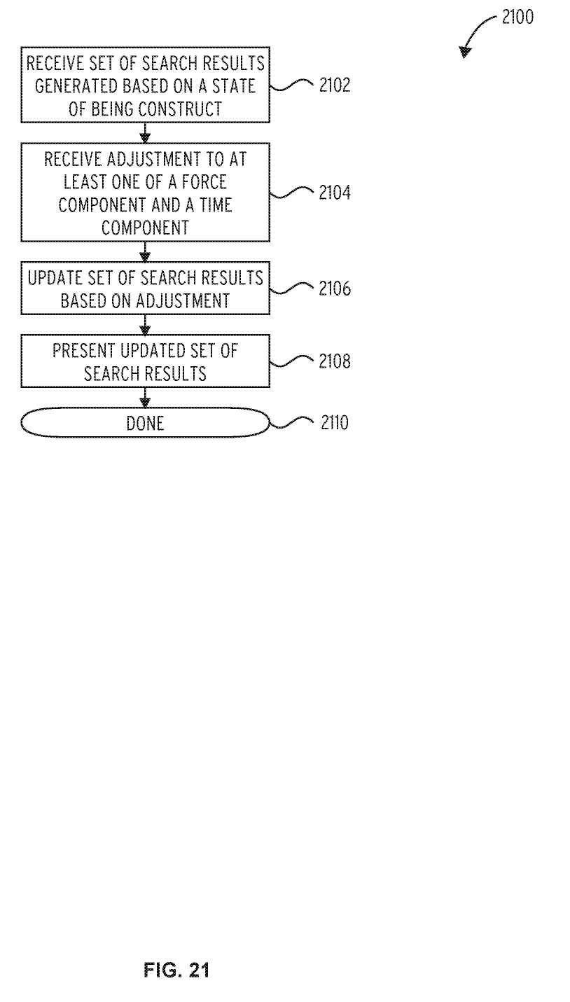

In an aspect, illustrated in FIG. 21, provided is a method 2100 comprising in block 2102, method 2100 receives a set of search results generated based on a state of being construct. In block 2104, method 2100 receives an adjustment to at least one of a force component and a time component. In block 2106, method 2100 updates the set of search results based on the adjustment. In block 2108, method 2100 presents the updated set of search results. In block 2110, method 2100 ends.

In some embodiments, a method may include receiving a set of search results generated based on a state of being construct, receiving an adjustment to at least one of a force component and a time component, updating the set of search results based on the adjustment, and/or presenting the updated net of search results. In some embodiments, the force component may include a value indicative of a level of effort required by a user. In some embodiments, the time component may include a value indicative of an amount of time a user is willing to dedicate.

In some embodiments, receiving a set of search results generated based on a state of being construct may include receiving a search term, accessing the state of being construct wherein the state of being construct comprises user data in a plurality of domains, determining a relevance of a search result to the search term, determining an applicability of a domain of the plurality of domains to the search result, and/or assigning a search result position to the search result based on the relevance and the applicability.

In some embodiments, the user data may include information related to a user at a present state. In some embodiments, the user data may include information related to a user at a future state. In some embodiments, the plurality of domains may include a religion domain, a politics domain, a financial domain, a geographic domain, a racial domain, a physical health domain, and a mental health domain.

In some embodiments, determining a relevance of a search result to the search term may include identifying one or more search results that comprise the search term. In some embodiments, determining an applicability of a domain of the plurality of domains to the search result may include determining a relevance of the search result to one or more keywords or concepts that comprise the domain of the plurality of domains. In some embodiments, determining a relevance of a search result to the search term may include determining one or more of a domain-level link feature, a page-level link feature, a page-level keyword feature, a page-level content-based feature, a page-level keyword-agnostic feature, engagement data, traffic/query data, domain-level brand metrics, domain-level keyword usage, domain-level keyword-agnostic feature, page-level social metrics, and combinations thereof.

In some embodiments, receiving an adjustment to at least one of a force component and a time component may include receiving a change in one or more of the value indicative of the level of effort required by the user and the value indicative of the amount of time the user is willing to dedicate. In some embodiments, receiving an adjustment to at least one of a force component and a time component may include receiving an input from one or more of a slider, a button, a dial, a check box, and combinations thereof.

In some embodiments, updating the set of search results based on the adjustment may include re-assigning the search result position to the search result based on at least one of the force component and the time component.

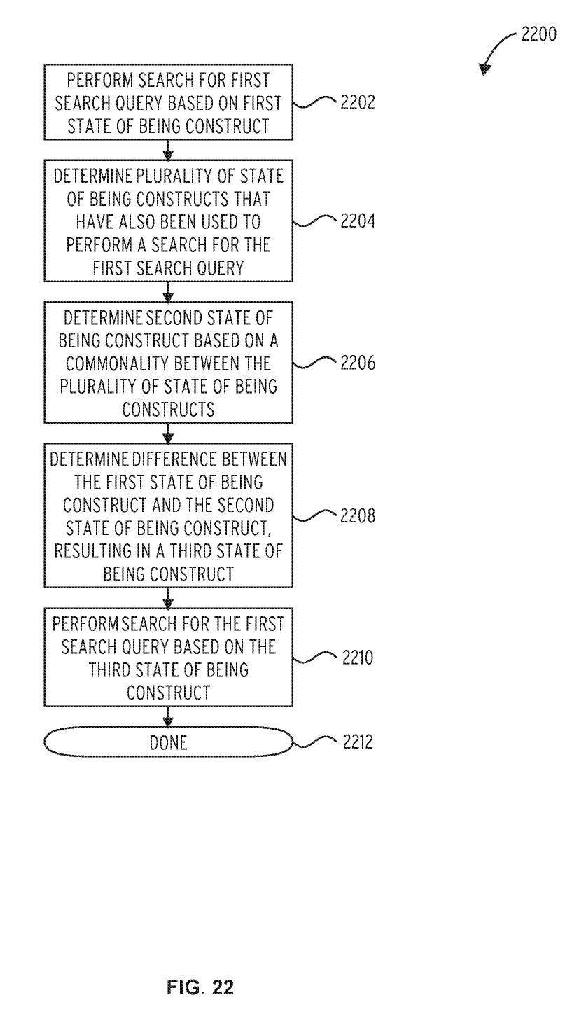

In an aspect, illustrated in FIG. 22, provided is a method 2200 comprising in block 2202, method 2200 performs a search for a first search query based on a first state of being construct. In block 2204, method 2200 determines a plurality of state of being constructs that have also been used to perform a search for the first search query. In block 2206, method 2200 determines a second state of being construct based on a commonality between the plurality of state of being constructs. In block 2208, method 2200 determines a difference between the first state of being construct and the second state of being construct, resulting in a third state of being construct. In block 2210, method 2200 performs the search for the first search query based on the third state of being construct. In block 2212, method 2200 ends.

In some embodiments, a method may include performing a search for a first search query based on a first state of being construct, determining a plurality of state of being constructs that have also been used to perform a search for the first search query, determining a second state of being construct based on a commonality between the plurality of state of being constructs, determining a difference between the first state of being construct and the second state of being construct, resulting in a third state of being construct, and performing the search for the first search query based on the third state of being construct.

In some embodiments, performing the search for the first search query based on the first state of being construct may include receiving a search term, accessing the first state of being construct, wherein the first state of being construct comprises user data in a plurality of domains, determining a relevance of a search result to the search term, determining an applicability of a domain of the plurality of domains to the search result, and assigning a search result position to the search result based on the relevance and the applicability.

In some embodiments, the user data may include information related to a user at a present state. In some embodiments, the user data may include information related to a user at a future state. In some embodiments, the plurality of domains may include a religion domain, a politics domain, a financial domain, a geographic domain, a racial domain, a physical health domain, and a mental health domain.

In some embodiments, determining the plurality of state of being constructs that have also been used to perform the search for the first search query comprises accessing a database comprising the plurality of state of being constructs wherein each of the plurality of state of being constructs is associated with one or more previously performed search queries, determining a subset of the plurality of state of being constructs that previously performed the first search query, and retrieving the subset of the plurality of state of being constructs.

In some embodiments, determining the second state of being construct based on the commonality between the plurality of state of being constructs comprises determining one or more keywords and/or one or more concepts in common among the subset of the plurality of state of being constructs and assembling the one or more keywords and/or one or more concepts into the second state of being construct.

In some embodiments, determining the difference between the first state of being construct and the second state of being construct, resulting in the third state of being construct comprises determining one or more keywords and/or concepts found in the first state of being construct that are not found in the second state of being construct and assembling the one or more keywords and/or concepts found in the first state of being construct that are not found in the second state of being construct into the third state of being construct.

In some embodiments, performing the search for the first search query based on the third state of being construct comprises receiving a search term, accessing the third state of being construct, wherein the third state of being construct comprises user data in a plurality of domains, determining a relevance of a search result to the search term, determining an applicability of a domain of the plurality of domains to the search result, and assigning a search result position to the search result based on the relevance and the applicability.

In an aspect, illustrated in FIG. 3, provided is a method 2300 comprising in block 2302, method 2300 receives a first state of being construct. In block 2304, method 2300 performs a clustering operation on the first state of being construct and a plurality of state of being constructs. In block 2306, method 2300 identifies one or more clusters that comprise one or more of the first state of being construct and the plurality of state of being constructs. In block 2308, method 2300 generates a description of each of the one or more clusters. In block 2310, method 2300 provides a searchable database comprising the description of each of the one or more clusters. In block 2312, method 2300 ends.

In some embodiments, a method may include receiving a first state of being construct, performing a clustering operation on the first state of being construct and a plurality of state of being constructs, identifying one or more clusters that comprise one or more of the first state of being construct and the plurality of state of being constructs, generating a description of each of the one or more clusters, and/or providing a searchable database.

In some embodiments, the first state of being construct comprises information related to a user at a present state. In some embodiments, the first state of being construct comprises information related to a user at a future state. In some embodiments, the first state of being construct may include a religion domain, a politics domain, a financial domain, a geographic domain, a racial domain, a physical health domain, and a mental health domain. In some embodiments, the first state of being construct may include a weight that comprises a value indicative of an importance of the domain. In some embodiments, the first state of being construct may include a time component that comprises a value indicative of an amount of time a user is willing to dedicate. In some embodiments, the first state of being construct may include a force component that comprises a value indicative of a level of effort required by a user. In some embodiments, the first state of being construct may include a data structure configured for filtering one or more search results and/or one or more search queries.

In some embodiments, performing the clustering operation on the first state of being construct may include performing one or more of a hierarchical clustering operation, a k-means operation, and combinations thereof. In some embodiments, generating the description of each of the one or more clusters comprises generating a summary of domains shared amongst state of being constructs found within a cluster. In some embodiments, providing the searchable database comprising the description of each of the one or more clusters comprises providing a search interface configured for searching the searchable database according to one or more of a religion domain, a politics domain, a financial domain, a geographic domain, a racial domain, a physical health domain, and a mental health domain. In some embodiments, the search interface is further configured for searching the searchable database according to at least one of a force component and a time component.

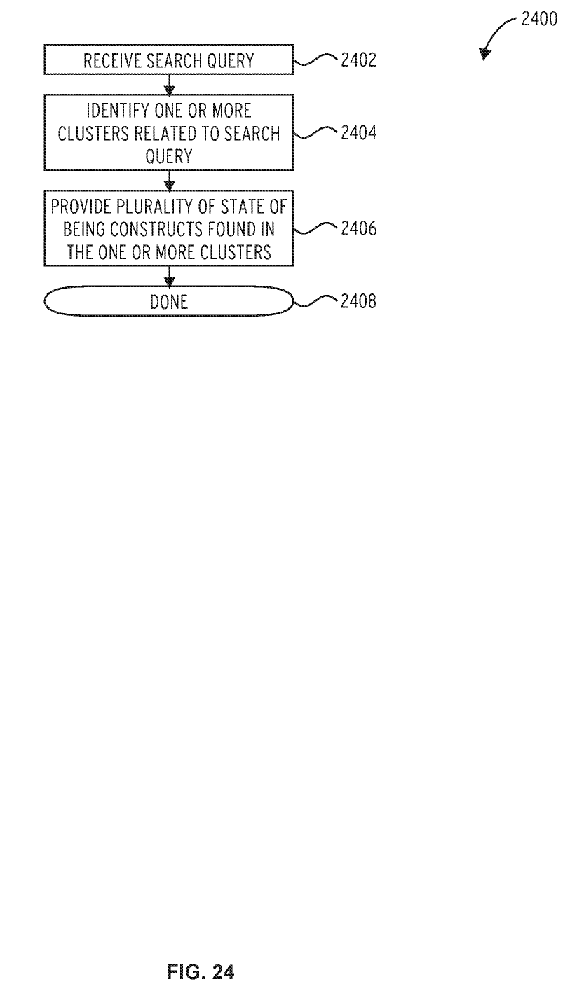

In an aspect, illustrated in FIG. 24, provided is a method 2400 comprising in block 2402, method 2400 receives a search query. In block 2404, method 2400 identifies one or more clusters related to the search query. In block 2406, method 2400 provides a plurality of state of being constructs found in the one or more clusters. In block 2408, method 2400 ends.

In some embodiments, a method may include receiving a search query, identifying one or more clusters related to the search query, and/or providing a plurality of state of being constructs found in the one or more clusters. In some embodiments, such a method may further include providing a search interface configured for searching a searchable database according to one or more of a religion domain, a politics domain, a financial domain, a geographic domain, a racial domain, a physical health domain, and a mental health domain. In some embodiments, the search interface is further configured for searching the searchable database according to at least one of a force component and a time component. In some embodiments, the searchable database may include a description of each of the one or more clusters.

In some embodiments, the description of each of the one or more clusters comprises a summary of domains shared amongst state of being constructs found within a cluster. In some embodiments, identifying the one or more clusters related to the search query comprises determining the one or more clusters having a description comprising a term or concept in common with the search query. In some embodiments, identifying the one or more clusters related to the search query may include performing a clustering operation on the search query. In some embodiments, the clustering operation may include a hierarchical clustering operation, a k-means operation, and combinations thereof. In some embodiments, each of the plurality of state of being constructs may include information related to a user at a present state. In some embodiments, each of the plurality of state of being constructs may include information related to a user at a future state. In some embodiments, each of the plurality of state of being constructs may include a religion domain, a politics domain, a financial domain, a geographic domain, a racial domain, a physical health domain, and a mental health domain.

In some embodiments, each of the plurality of state of being constructs may include a weight that comprises a value indicative of an importance of the domain. In some embodiments, each of the plurality of state of being constructs may include a time component that comprises a value indicative of an amount of time a user is willing to dedicate. In some embodiments, each of the plurality of state of being constructs may include a force component that comprises a value indicative of a level of effort required by a user. In some embodiments, each of the plurality of state of being constructs may include a data structure configured for filtering one or more search results and/or one or more search queries.

In some embodiments, providing the plurality of state of being constructs found in the one or more clusters comprises outputting the plurality of state of being constructs to an output device. In some embodiments, the method can further comprise identifying a plurality of users associated with the plurality of state of being constructs. In some embodiments, the method can further comprise receiving a potential search result, an advertisement, or a combination thereof marked for delivery in response to a future search by one of the plurality of users or a user having a state of being construct similar to the plurality of state of being constructs.

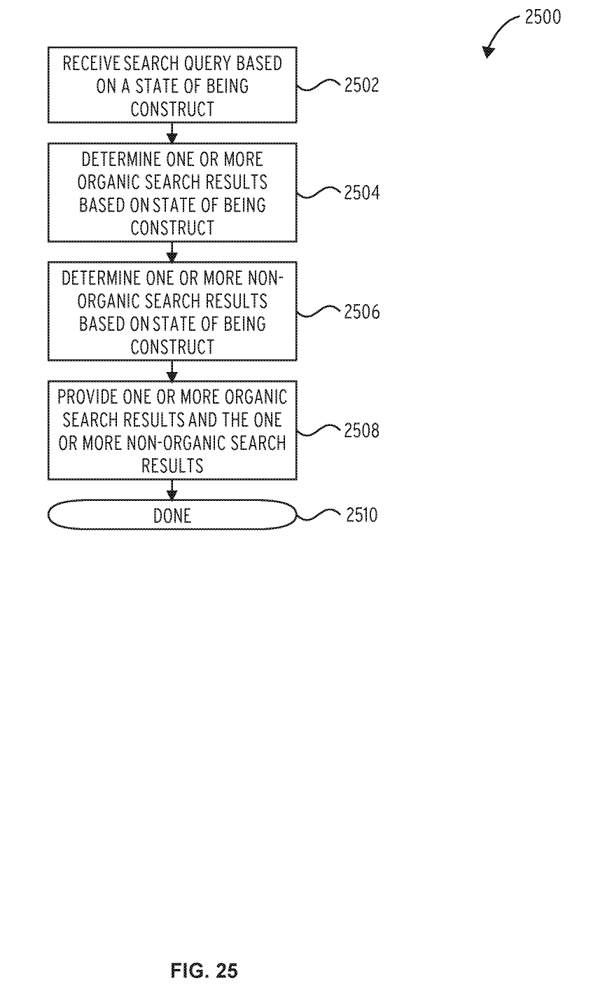

In an aspect, illustrated in FIG. 25, provided is a method 2500 comprising in block 2502, method 2500 receives a search query based on a state of being construct. In block 2504, method 2500 determines one or more organic search results based on the state of being construct. In block 2506, method 2500 determines one or more non-organic search results based on the state of being construct. In block 2508, method 2500 and provides the one or more organic search results and the one or more non-organic search results. In block 2510, method 2500 ends.

In some embodiments, receiving the search query based on the state of being construct comprises receiving a search term and accessing the state of being construct, wherein the state of being construct comprises user data in a plurality of domains.

In some embodiments, determining one or more organic search results based on the state of being construct comprises determining a relevance of a potential organic search result to the search term by identifying the potential organic search result that comprises a keyword in common with a domain of the state of being construct, determining an applicability of a domain of the plurality of domains to the potential organic search result, and classifying the potential organic search result as the one or more organic search results based on the relevance and the applicability.

In some embodiments, determining one or more non-organic search results based on the state of being construct comprises determining a relevance of a potential non-organic search result to the search term by identifying the potential non-organic search result that has been previously identified as relevant to a plurality of state of being constructs similar to the state of being construct and classifying the potential non-organic search result as the one or more non-organic search results based on the relevance.

In some embodiments, determining one or more non-organic search results based on the state of being construct comprises comparing the state of being construct to a plurality of product descriptions to identify a related product, identify an advertisement for the related product, and classifying the advertisement as the one or more non-organic search results.

In some embodiments, determining one or more non-organic search results based on the state of being construct comprises processing the state of being construct according to a taxonomy to identify a related product, identify an advertisement for the related product, and classifying the advertisement as the one or more non-organic search results.

In some embodiments, the method 2500 can further comprise assigning a search result position to the one or more organic search results and the one or more non-organic search results. Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification,

While the methods and systems have been described in connection with preferred embodiments and specific examples, it is not intended that the scope be limited to the particular embodiments set forth, as the embodiments herein are intended in respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following claims.

What is claimed is:

1. A method comprising:
performing a search for a first search query based on a first state of being construct;
determining a plurality of state of being constructs that have also been used to perform a search for the first search query;
determining a second state of being construct based on a commonality between the plurality of state of being constructs;
determining a difference between the first state of being construct and the second state of being construct, resulting in a third state of being construct; and
performing the search for the first search query based on the third state of being construct.

2. The method of claim 1 wherein performing the search for the first search query based on the first state of being construct comprises:
receiving a search term;
accessing the first state of being construct, wherein the first state of being construct comprises user data in a plurality of domains;
determining a relevance of a search result to the search term;
determining an applicability of a domain of the plurality of domains to the search result; and
assigning a search result position to the search result based on the relevance and the applicability.

3. The method of claim 2 wherein the user data comprises information related to a user at a present state.

4. The method of claim 2 wherein the user data comprises information related to a user at a future state.

5. The method of claim 2 wherein the plurality of domains comprises a religion domain, a politics domain, a financial domain, a geographic domain, a racial domain, a physical health domain, and a mental health domain.

6. The method of claim 2 determining a relevance of the search result to the search term comprises identifying one or more search results that comprises the search term.

7. The method of claim 1 wherein determining the plurality of state of being constructs that have also been used to perform the search for the first search query comprises:
accessing a database comprising the plurality of state of being constructs wherein each of the plurality of state of being constructs is associated with one or more previously performed search queries;
determining a subset of the plurality of state of being constructs that previously performed the first search query; and
retrieving the subset of the plurality of state of being constructs.

8. The method of claim 1 wherein determining the second state of being construct based on the commonality between the plurality of state of being constructs comprises:
determining one or more keywords and/or one or more concepts in common among the subset of the plurality of state of being constructs; and
assembling the one or more keywords and/or one or more concepts into the second state of being construct.

9. The method of claim 1 wherein determining the difference between the first state of being construct and the second state of being construct, resulting in the third state of being construct comprises:
determining one or more keywords and/or concepts found in the first state of being construct that are not found in the second state of being construct; and
assembling the one or more keywords and/or concepts found in the first state of being construct that are not found in the second state of being construct into the third state of being construct.

10. The method of claim 1 wherein performing the search for the first search query based on the third state of being construct comprises:
receiving a search term;
accessing the third state of being construct, wherein the third state of being construct comprises user data in a plurality of domains;
determining a relevance of a search result to the search term;
determining an applicability of a domain of the plurality of domains to the search result; and
assigning a search result position to the search result based on the relevance and the applicability.

11. A non-transitory computer-readable storage medium comprising instructions that when executed by a computer, cause the computer to:
perform a search for a first search query based on a first state of being construct;
determine a plurality of state of being constructs that have also been used to perform a search for the first search query;
determine a second state of being construct based on a commonality between the plurality of state of being constructs;
determine a difference between the first state of being construct and the second state of being construct, resulting in a third state of being construct; and
perform the search for the first search query based on the third state of being construct.

12. The computer-readable storage medium of claim 11 wherein performing the search for the first search query based on the first state of being construct comprises:
receive a search term;
access the first state of being construct, wherein the first state of being construct comprises user data in a plurality of domains;
determine a relevance of a search result to the search term;
determine an applicability of a domain of the plurality of domains to the search result; and
assign a search result position to the search result based on the relevance and the applicability.

13. The computer-readable storage medium of claim 12 wherein the user data comprises information related to a user at a present state.

14. The computer-readable storage medium of claim 12 wherein the user data comprises information related to a user at a future state.

15. The computer-readable storage medium of claim 12 wherein the plurality of domains comprises a religion domain, a politics domain, a financial domain, a geographic domain, a racial domain, a physical health domain, and a mental health domain.

16. The computer-readable storage medium of claim 12 determine a relevance of the search result to the search term comprises identifying one or more search results that comprises the search term.

17. The computer-readable storage medium of claim 11 wherein determining the plurality of state of being constructs that have also been used to perform the search for the first search query comprises:
access a database comprising the plurality of state of being constructs wherein each of the plurality of state of being constructs is associated with one or more previously performed search queries;
determine a subset of the plurality of state of being constructs that previously performed the first search query; and
retrieve the subset of the plurality of state of being constructs.

18. The computer-readable storage medium of claim 11 wherein determining the second state of being construct based on the commonality between the plurality of state of being constructs comprises:
determine one or more keywords and/or one or more concepts in common among the subset of the plurality of state of being constructs; and
assemble the one or more keywords and/or one or more concepts into second state of being construct.

19. The computer-readable storage medium of claim 11 wherein determining the difference between the first state of being construct and the second state of being construct, resulting in the third state of being construct comprises:
determine one or more keywords and/or concepts found in the first state of being construct that are not found in the second state of being construct; and
assemble the one or more keywords and/or concepts found in the first state of being construct that are not found in the second state of being construct into the third state of being construct.

20. A computing apparatus comprising:
a processor; and
a memory storing instructions that, when executed by the processor, configure the apparatus to:
perform a search for a first search query based on a first state of being construct;
determine a plurality of state of being constructs that have also been used to perform a search for the first search query;
determine a second state of being construct based on a commonality between the plurality of state of being constructs;
determine a difference between the first state of being construct and the second state of being construct, resulting in a third state of being construct; and
perform the search for the first search query based on the third state of being construct.
